(19) United States
(12) Patent Application Publication
(10) Pub. No.: US 2024/0158259 A1
(43) Pub. Date: May 16, 2024

(54) TRANSITION METAL OXIDE-BASED BINDER-FREE ELECTRODE FOR LITHIUM-ION BATTERIES AND MANUFACTURING METHOD THEREOF

(71) Applicant: KOREA UNIVERSITY RESEARCH AND BUSINESS FOUNDATION, Seoul (KR)

(72) Inventors: Won Joon CHOI, Seoul (KR); Woo Sung KIM, Seoul (KR); Byung Seok SEO, Seoul (KR)

(21) Appl. No.: 18/373,437

(22) Filed: Sep. 27, 2023

(30) Foreign Application Priority Data
Nov. 8, 2022 (KR) 10-2022-0147931
Sep. 4, 2023 (KR) 10-2023-0117040

(51) Int. Cl. C01G 53/00

(52) U.S. Cl. CPC C01G 53/40; C01P 2004/10

(57) ABSTRACT

A method of manufacturing a binder-free electrode includes hydrothermally synthesizing a transition metal oxide-based active material on a 3D porous substrate; and using electrothermal waves on the substrate on which the transition metal oxide-based active material is hydrothermally synthesized. Consequently, a transition metal oxide/conductive substrate composite can be synthesized within a few seconds.

### CROSS-REFERENCE TO RELATED APPLICATIONS

This application claims the benefit under 35 U.S.C. 119(a) of Korean Patent Application No. 10-2022-0147931 filed on Nov. 8, 2022 and Korean Patent Application No. 10-2023-0117040 filed on Sep. 4, 2023 in the Korean Intellectual Property Office, the entire disclosure of which is incorporated herein by reference for all purposes.

### BACKGROUND

### 1. Field

The following description relates to a transition metal oxide-based binder-free electrode for lithium-ion batteries and a manufacturing method thereof and in particular to a transition metal oxide-based binder-free electrode using programmable electrothermal waves and a manufacturing method thereof.

### 2. Description of Related Art

Lithium-ion batteries (LIB) are used in various applications due to their high voltage and high energy density. For example, in fields such as electric vehicles, which need to operate at high temperatures and require the capability to charge and discharge large amounts of electricity, lithium-ion batteries with excellent discharge capacity are required.

The development of advanced electrodes to increase the capacity of lithium-ion batteries has generated significant interest in reducing the volume and weight of energy storage cells. To meet the rapidly increasing demands for high energy and power density as well as cycling stability, it is particularly important to overcome the low theoretical capacity (˜372 mAh g⁻¹) of anode materials including graphite carbon.

Therefore, significant efforts have been made to develop transition metal oxides (TMO) as alternative anode materials dues to their higher capacity (˜1200 mAh g⁻¹) compared to graphite-based anode materials. Among transition metal oxides, cobalt (II, III) oxide (CO₃O₄) has attracted considerable attention as an anode material due to its high theoretical capacity (˜890 mAh g⁻¹) and large reserve. However, their low electrical conductivity, inherent thermodynamic instability, and volume expansion during charge and discharge cycles are issues that need to be addressed for practical use in anode. To address these inherent limitations, various strategies have been researched to optimize the chemical composition and surface morphology of cobalt oxide (CO₃O₄) nanostructures with a large surface area.

Meanwhile, along with the rapid advancement of active materials with optimized physicochemical characteristics, the development of binder-free electrodes has emerged as a promising approach not only for mitigating capacity and conductivity degradation but also for achieving efficient manufacturing processes. When the synthesized active materials are integrated into battery cells, the use of additional binders such as poly(vinylidene fluoride) and poly(vinyl alcohol), as well as conductive additives such as acetylene black and Super P is necessary to complete the working electrode. Support materials are electrochemically inert and thus can reduce the electrode's capacity.

Furthermore, the poor interface boundaries between constituent components, for example, imperfect contact between unevenly distributed active materials and the substrate, can lead to a decrease in the electron transfer rate and ion diffusion efficiency of the electrolyte. A binder-free electrode design can provide excellent electron/charge transfer dynamics, adjustable free spaces for serving volume expansion, and an extended substrate.

However, the conventional synthetic routes for binder-free electrodes, which involve annealing and electrodeposition, are time-consuming and require bulky equipment for each step of the synthesis. Furthermore, achieving a finely optimized binder-free design to enhance performance is challenging because once the active materials are anchored to the substrate, it becomes difficult to control a wider range of subtle structural changes.

As computational approaches for modeling the optimal design of electrodes have recently been rigorously developed, it has become essential to swiftly prepare and analyze binder-free electrodes with precisely tuned phases and their corresponding electrochemical performances for rapid screening of the best binder-free electrodes using specific active materials.

Therefore, for the production of next-generation electrodes, it is rational to develop easily accessible yet precise synthesis methods for transition metal oxide-based binder-free electrodes to enable scalable fabrication.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure aims to address the aforementioned issues and introduces a transition metal oxide-based binder-free electrode using programmable electrothermal waves and a manufacturing method thereof.

In one general aspect, a method for manufacturing a binder-free electrode according to an example of the present disclosure includes hydrothermally synthesizing a transition metal oxide-based active material on a 3D porous substrate; and using electrothermal waves to the 3D porous substrate on which the transition metal oxide-based active material is hydrothermal synthesized.

The 3D porous substrate may include a conductive metal material of any one of stainless steel, aluminum, nickel, titanium, and heat-treated carbon.

The transition metal oxide-based active material may include a mixture of inorganic N-based precursors, where N is one or more metals from a group of Mg, Ti, Fe, Cu, Ca, Ba, Y, Sn, Sb, Na, Zn, Zr, Si, Nb, Mo, Ru, Rh, Pd, Ag, Cd, Sc, Ce, Pr, Nd, Gd, Dy, and Er.

The hydrothermal synthesis may include hydrothermally synthesizing a cobalt precursor on a nickel foam.

The hydrothermal synthesis may include forming needle-like nanostructures of cobalt hydroxide on the nickel foam.

The using electrothermal waves may include making transition from the cobalt hydroxide to a cobalt oxide by Joule-heating-driven electrothermal waves passing through the nickel foam while preserving the needle-like nanostructures.

The using electrothermal waves may include synthesizing a cobalt oxide/nickel foam composite by using Joule heating applying electric energy to both ends of the 3D porous substrate.

The using electrothermal waves may include synthesizing a transition metal oxide/conductive substrate composite by Joule-heating the substrate on which the transition metal oxide-based active material is formed.

The using electrothermal waves may include performing a pulse cycle with a heating duration of 5 seconds and a cooling duration of 20 seconds.

In another general aspect, a binder-free electrode includes a substrate of a 3D porous conductive metal material; and a transition metal oxide-based active material in form of a needle-like nanostructure hydrothermally synthesized on the substrate and then oxidized using electrothermal waves.

The substrate may include a conductive metal material of any one of stainless steel, aluminum, nickel, titanium, and heat-treated carbon.

Preferably, the substrate may be a 3D porous nickel foam.

The transition metal oxide-based active material may include a mixture of inorganic N-based precursors, where N is one or more metals from a group of Mg, Ti, Fe, Cu, Ca, Ba, Y, Sn, Sb, Na, Zn, Zr, Si, Nb, Mo, Ru, Rh, Pd, Ag, Cd, Sc, Ce, Pr, Nd, Gd, Dy, and Er.

Preferably, the transition metal oxide-based active material may be cobalt oxide (CO₃O₄).

A binder-free electrode and a manufacturing method thereof according to the present disclosure may synthesize a transition metal oxide/conductive substrate composite within a few seconds by using electrothermal waves by forming a transition metal precursor on a conductive substrate with a 3D porous structure.

Furthermore, by controlling the conditions of the electrothermal waves, it may be possible to organically control the chemical properties of the transition metal oxide/conductive substrate composite.

Moreover, through the hydrothermal synthesis method, it may be possible to synthesize a transition metal composite advantageous for electrochemical applications as it allows the preservation of the inherent structural characteristics (needle-like nanoarray) of the transition metal precursors.

Additionally, using the transition metal oxide/conductive substrate composite as a lithium-ion battery anode that does not need binders allows its integration into coin cells alongside lithium chips. This can lead to achieving high battery performance.

### BRIEF DESCRIPTION OF THE DRAWINGS

FIG. 1 illustrates a flowchart for explaining a method of manufacturing a binder-free electrode according to an embodiment of the present disclosure.

FIG. 2 illustrates a process view for briefly showing a method of manufacturing a binder-free electrode according to an embodiment of the present disclosure.

FIGS. 3A to 3C illustrate views of Scanning Electron Microscope (SEM) images of a substate in accordance with the process sequence shown in FIG. 2.

FIG. 3D illustrates a graph showing the results of thermogravimetric analysis (TGA) according to temperature variations of the cobalt oxide/nickel foam composite prepared via the electrothermal waves shown in FIG. 2A.

FIGS. 3E to 3G illustrate views for explaining process conditions for the electrothermal waves shown in FIG. 2.

FIGS. 4A to 4C illustrate views of physicochemical characteristics of a binder-free electrode according to an embodiment of the present disclosure.

FIGS. 5A to 5F illustrate views of a comparison of the physicochemical characteristics between a binder-free electrode according to various embodiments of the present disclosure and a comparative example.

FIGS. 6A to 6F illustrate views of phase transition changes between a binder-free electrode according to various embodiments of the present disclosure and a comparative example.

FIG. 7 illustrates an example view of the structure of a lithium secondary battery using a binder-free electrode according to an embodiment of the present disclosure.

FIGS. 8A to 8J illustrate views of a comparison of the electrochemical characteristics between the lithium secondary battery in FIG. 7 and a comparative example.

### DETAILED DESCRIPTION

Hereinafter, preferred examples of the present disclosure will be described in detail with reference to the accompanying drawings in order to clarify the technical spirit of the present disclosure. In describing the present disclosure, if it is determined that a detailed description of a related known function or component may unnecessarily obscure the subject matter of the present disclosure, the detailed description will be omitted. Components having substantially the same functional configuration in the drawings are given the same reference numerals and signs as much as possible, even though they are displayed on different drawings. For convenience of description, the device and method are described together if necessary.

Binder-free electrodes manufactured using only active materials within the electrode are emerging as the next-generation anode (or cathode) for lithium secondary batteries. As active materials, transition metal oxides with high theoretical capacity are being used, but the need for research on property modifications has arisen due to their low electrical conductivity and significant volume expansion during charge and discharge. However, due to the property of binder-free electrodes, where active materials are in physical contact with the substrate, it is very difficult to independently control the physicochemical properties of only the active material using existing synthesis methods.

In this regard, the present disclosure utilizes an electrothermal wave (ETW) to directly synthesize active materials onto the substrate (current collector) and independently modify the physiochemical properties of these materials for optimizing battery performance. Here, the electrothermal wave process is a technology that supplies thermal energy within the system by applying electrical energy to both ends of a conductive substrate, inducing Joule heating on the substrate. This causes a rapid increase in temperature due to internal resistance, reaching high temperatures (up to 2,500° C. or lower) within a few seconds, allowing for material synthesis. The electrothermal process can be applied in various contexts, including the synthesis of metals and metal oxides requiring high-temperature processes or interface modification with dielectric devices. Materials synthesized through this method are then applied to energy conversion components following optimization of their electrochemical properties. In contrast to traditional annealing processes that require maintaining high temperatures for extended periods, which can be inefficient in terms of time and cost, the electrochemical process is much more effective because it occurs in a very short timeframe.

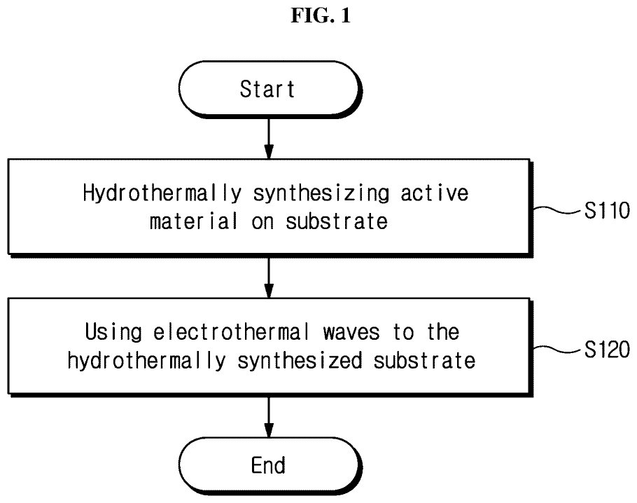

FIG. 1 illustrates a flowchart for explaining a method of manufacturing a binder-free electrode according to an embodiment of the present disclosure.

Referring to FIG. 1, in a method of manufacturing a binder-free electrode, a transition metal oxide-based active material is hydrothermally synthesized on a substrate that is a three-dimensional porous conductive metal material (S110). Here, the substrate is not particularly limited as long as it has conductivity without causing a chemical change in the battery. For example, it may include any conductive metal material such as stainless steel, aluminum, nickel, titanium, and heat-treated carbon. Furthermore, it may include any conductive metal material that has been surface-treated with carbon, nickel, titanium, silver, etc. on the surface of aluminum or stainless steel. Preferably, the substrate may include 3D porous nickel (hereinafter referred to as “Ni foam”). The substrate may serve as a functional backbone in a synthesis process, providing a large surface area for active materials and electrothermal pathways using Joule-heating.

The transition metal oxide-based active material is of a mixture of inorganic N-based precursors, where N may be one or more metals selected from a group of Mg, Ti, Fe, Cu, Ca, Ba, Y, Sn, Sb, Na, Zn, Zr, Si, Nb, Mo, Ru, Rh, Pd, Ag, Cd, Sc, Ce, Pr, Nd, Gd, Dy, and Er. Preferably, it may be a cobalt precursor.

In embodiments, a cobalt precursor may be hydrothermally synthesized on Ni foam. At this time, needle-like nanostructures of cobalt hydroxide may be formed on the Ni foam by the cobalt precursor.

Subsequently, using electrothermal waves is performed on the substrate on which the transition metal oxide-based active material is hydrothermally synthesized (S120). In other words, by Joule-heating the substrate with the transition metal oxide-based active material, a transition metal oxide/conductive substate composite may be synthesized. This completes a binder-free electrode. With both a high grain boundary density and low oxygen vacancies, the binder-free electrode exhibits excellent electrical capacity at high current densities. In this case, the current and voltage flowing through the substrate during the electrothermal process may be measured, and the temperature during the electrothermal process may be calculated using the measured current and voltage.

In embodiments, a cobalt oxide/Ni foam composite may be synthesized via Joule-heating a substrate on which a cobalt precursor is hydrothermally synthesized by connecting a voltage supply device to both ends of the substrate to pass an electric current. In other words, cobalt oxide with a nanoarray structure may be synthesized on Ni foam within seconds by using electrothermal waves. This may mean that the Joule-heating-driven electrothermal waves passing through the Ni foam enables transition to cobalt oxides while preserving the needle-like nanostructures.

In addition, a cobalt oxide/Ni foam composite with a needle-like nanoarray may be synthesized by adjusting the applied voltage and current of the electrothermal process.

In the present disclosure, by using electrothermal waves, the structural characteristics of the initial transition metal precursor are not damaged, thereby preserving the initial transition metal structure.

In the present disclosure, instead of employing conventional processing methods, using electrothermal waves is employed to synthesize the cobalt oxide/Ni foam composite which is a binder-free electrode, enabling simultaneous adjustment structural and chemical characteristics of cobalt oxide. In addition, using electrothermal waves enables various structural differences depending on the magnitude and duration of power to apply the current, allowing for multiple optimizations of the target material.

Furthermore, according to the present disclosure, it has been confirmed, using various physical property analysis methods, that a cobalt oxide synthesized by using electrothermal waves had a higher grain boundary density and a much smaller amount of oxygen vacancies than a cobalt oxide synthesized by the conventional synthesis process (annealing). Detailed description will follow.

In the present disclosure, changes in the properties of cobalt oxide were observed during repetitive electrothermal processes, and it was confirmed that during additional electrothermal processes, the energy of the applied energy, which remains after being used for heat transfer and internal energy, induces the reduction reaction and particle agglomeration of cobalt oxide.

Furthermore, by confirming that the amount of oxygen vacancies remains unchanged even with repetitive electrothermal processes, it is possible to independently control the structural and chemical characteristics of transition metal oxides through electrothermal processes.

Moreover, the impact of differences in the properties of the active material on batter performance was observed. It can be seen that a higher grain boundary density can significantly improve capacity, and a longer lifespan for the battery can be ensured by optimally suppressing oxygen vacancies and preventing irregular volume expansion of cobalt oxide during charging and discharging.

Additionally, according to the present disclosure, it is possible to variably change the physical and chemical structure of the electrodes via using electrothermal waves to reveal a mechanism of battery performance, and based on this, it is possible to suggest a new transition metal oxide design strategy for high-capacity lithium secondary batteries.

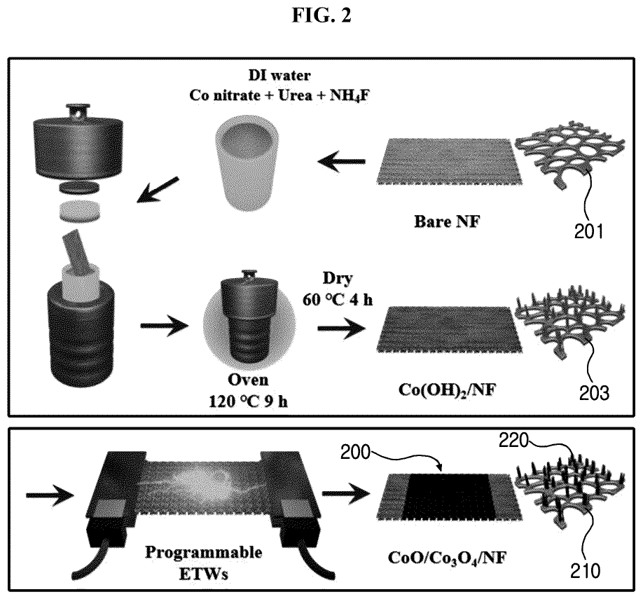

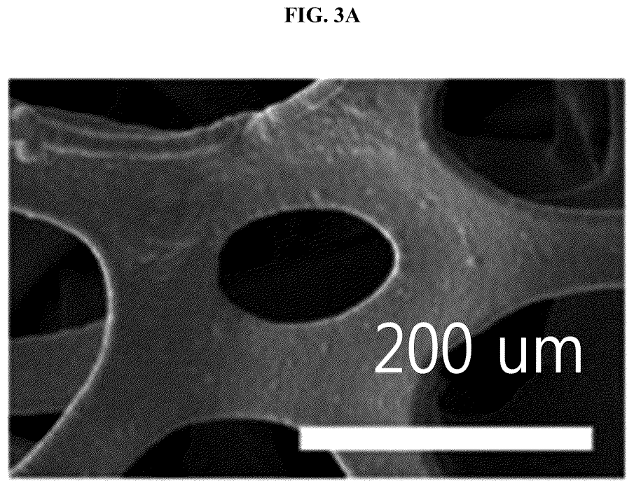

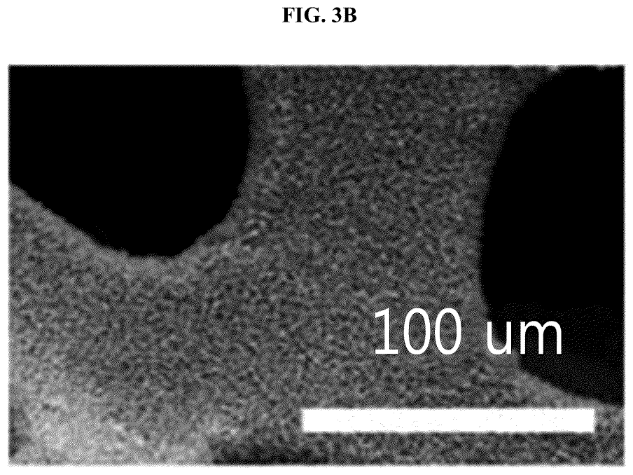

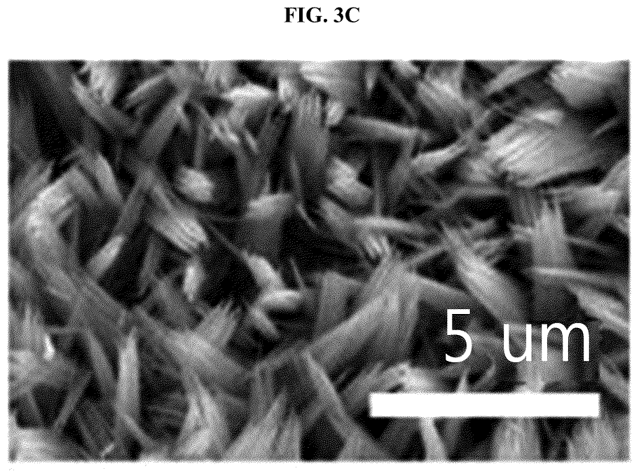

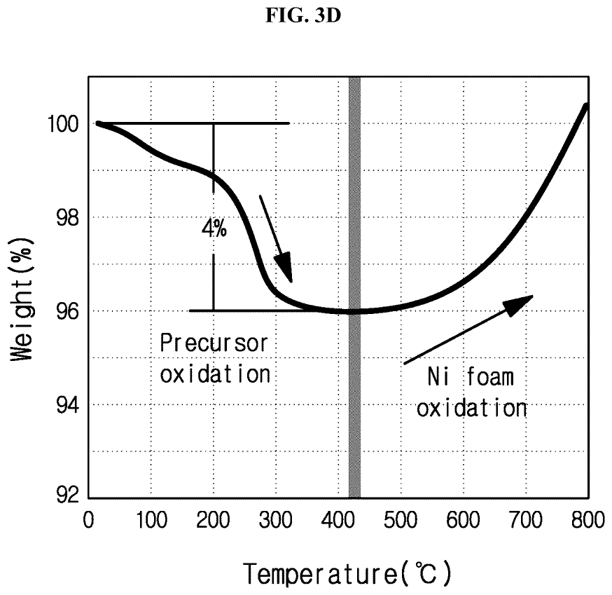

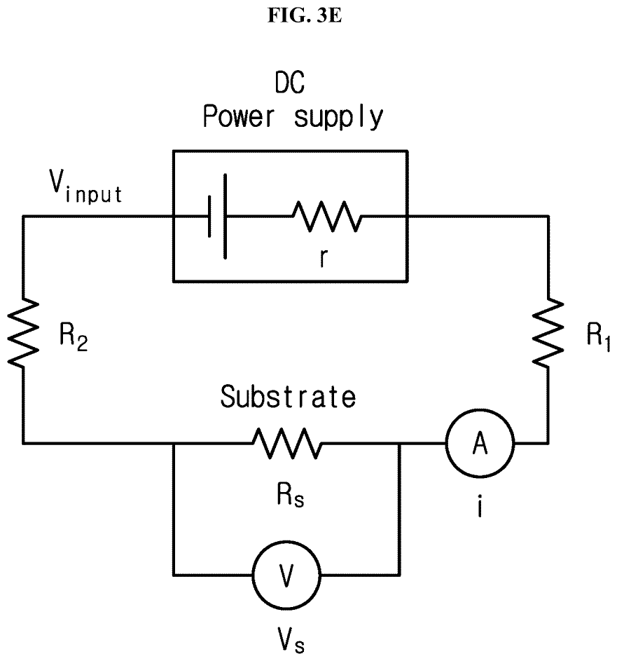

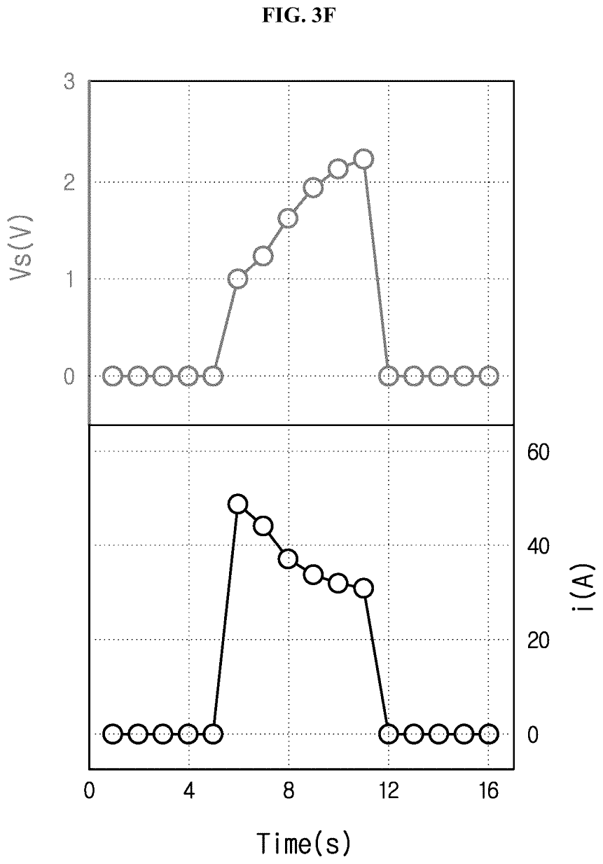

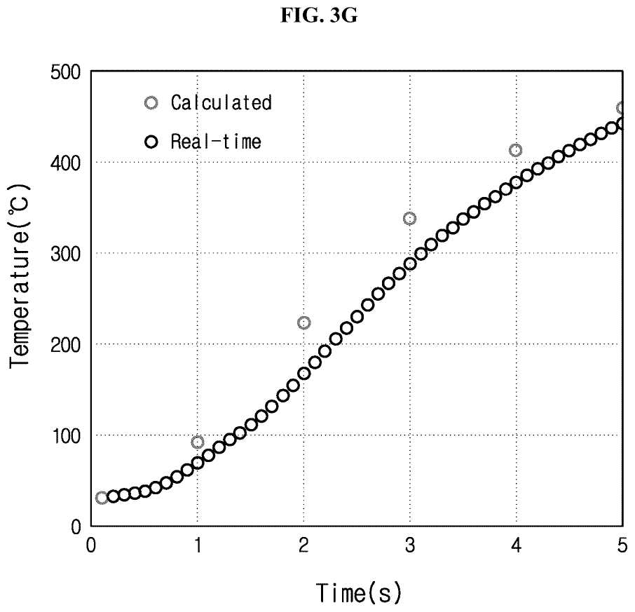

FIG. 2 illustrates a process view for briefly showing a method of manufacturing a binder-free electrode according to an embodiment of the present disclosure. FIGS. 3A to 3C illustrate views of Scanning Electron Microscope (SEM) images of a substate in accordance with the process sequence shown in FIG. 2. FIG. 3D illustrates a graph showing the results of thermogravimetric analysis according to temperature variations of the cobalt oxide/nickel foam composite prepared by using electrothermal waves shown in FIG. 2A. Here, FIG. 3A shows a scanning electron microscope (SEM) image of bare Ni foam, FIG. 3B shows an SEM image of needle-like nanostructures of cobalt array precursors on Ni foams prepared by a hydrothermal method, and FIG. 3C shows an SEM image of electrothermally synthesized cobalt oxide/Ni foam composite.

Referring to FIG. 2, a transition metal oxide-based active material is hydrothermally synthesized on a substrate 201 (S210).

First, a bare nickel foam 201, as shown in FIG. 3A, was immersed in a precursor mixture of cobalt nitrate (Co(NO₃)₂6H₂O), urea (CO(NH₂)₂), and ammonium fluoride (NH₄F), which are cobalt precursors, and then heated in an oven for 9 hours at 120° C., and naturally cooled to 25° C.

Subsequently, by drying it at 60° C. for 4 hours, the thin layer of the precursor can be formed into a needle-like nanoarray structure 203 of cobalt hydroxide (Co(OH)₂) attached to Ni foam, as shown in FIG. 3B.

Then, electrothermal waves are used for the substrate 203 hydrothermally synthesized with the transition metal oxide-based active material (S220).

In other words, by applying electric energy to both ends of the hydrothermally synthesized substrate to generate Joule-heating, a cobalt oxide/Ni foam composite (i.e., CoO/Co₃O₄@Ni foam) can be synthesized, as shown in FIG. 3C. At this time, electrothermal waves may be executed in a pulse cycle of a heating duration of 5 seconds and a cooling duration of 20 seconds. Electrothermal waves reflecting thermodynamic phases enable highly efficient, facile fabrication of cobalt oxide (CO₃O₄) nanostructures anchored on Ni foams. Subsequently, electrothermal waves, optimized in terms of electric field, current, and processing temperature, allows for the fabrication of precisely tuned cobalt oxide/Ni foam composite considering the grain boundaries and vacancies.

In short, the binder-free electrode 200 according to the present disclosure may include a 3D porous conductive metal material substrate 210 and a transition metal oxide-based active material 220 in form of a needle-like nanostructure hydrothermally synthesized on the substrate 210 and then oxidized through using electrothermal waves.

This enables the binder-free electrode to be used as an anode for lithium-ion batteries.

To set the operating parameters of programmable electrothermal waves capable of adjusting the transition metal oxide-based active materials, the thermodynamic transition and chemical decomposition of precursor mixtures may be investigated using thermogravimetric analysis (TGA). As shown in FIG. 3D, in the TGA results, the total mass consisting of cobalt-based hydroxides/oxides and Ni foams is reduced from 100% to 96%, indicating the lowest mass at 424.5° C. This implied that at temperatures above 400° C., all precursors may undergo phase transition. Over 424.5° C., the total mass increases because of the oxidation of the Ni foam.

Programmable Electrothermal Waves for Precise Synthesis of Binder-Free Electrode (CoO/Co₃O₄@Ni Foam)

FIGS. 3E to 3G illustrate views for explaining process conditions for the electrothermal waves in FIG. 2.

FIG. 3E illustrates a schematic diagram showing an electric circuit for the electrothermal waves shown in FIG. 2. FIG. 3F illustrates a graph showing real-time voltage-current profiles. FIG. 3G illustrates a graph showing temperature profile.

Referring to FIGS. 3E to 3G, in embodiments, the regulating parameters in an electric circuit of electrothermal waves were screened over 400° C., which can completely convert the hydrothermally synthesized cobalt hydroxide to a cobalt oxide-based electrode on the Ni foam.

Furthermore, the input parameters, such as contact resistances (R₁, R₂) and internal resistance (r), should be considered because they can inevitably cause voltage drop and current degradation. For instance, the input voltage and current (4.5 V and 50 A) resulted in a voltage drop and current degradation to give a voltage (V_{S}) of 1.7 V and current (i) of 38 A, respectively, in the electrothermal substrates. Inversely, the substrate resistance (R_{S}) can be calculated using the V_{S} and i measurements, and the temperature change of the substrate via the electrothermal wave can be derived from the Equation (1):

R_{S}=R₀(1+α(T−T₀)) (1)
where α denotes the temperature coefficient of resistivity. Thus, the time required for the sustained electrothermal waves to obtain the transition temperature (over 424.5° C.) can be calculated at the estimated R_{S} value. Based on the correlation plot, the 5-second duration of the electrothermal waves can raise the substrate temperature to 459.9° C., enabling the full reformation of the cobalt-based active material. The fitted temperature correlation with time is consistent with the experimentally measured real-time temperature profiles.

In this regard, threshold setting parameters of electrothermal waves enable the rapid synthesis of cobalt oxide nanostructures on Ni foam via the complete decomposition of cobalt hydroxide, and the fine-tuning of the regulating parameters enable rapid yet efficient tuning of the cobalt oxide/Ni foam composite in terms of multiple physicochemical properties, such as morphology, grain boundaries, and oxygen vacancies.

Physicochemical Characteristics of Binder-Free Electrode by One-Step Electrothermal Wave

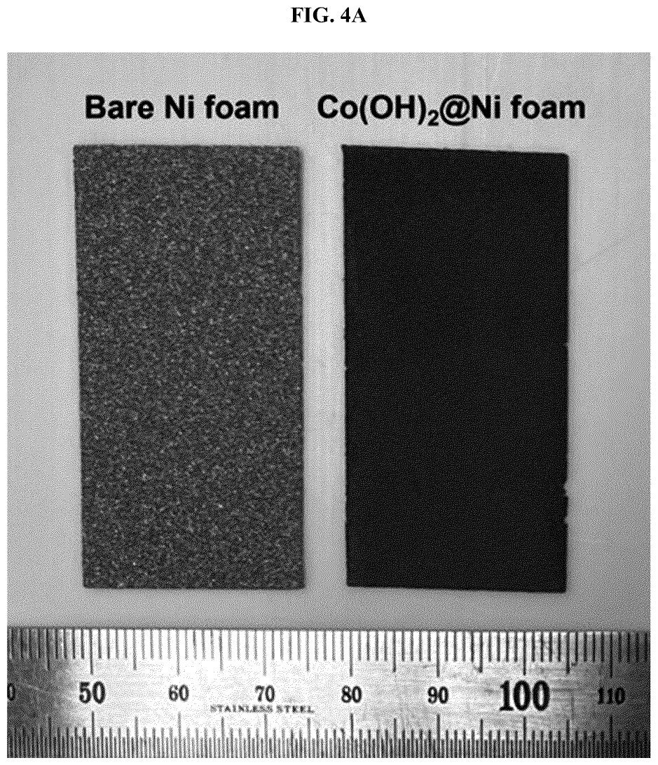

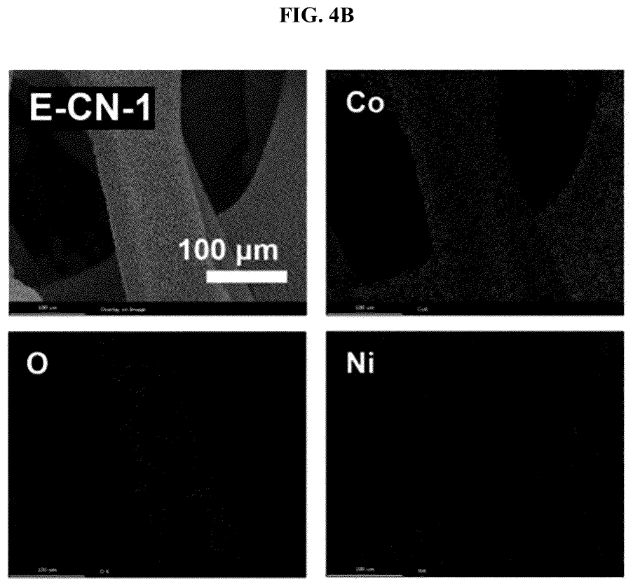

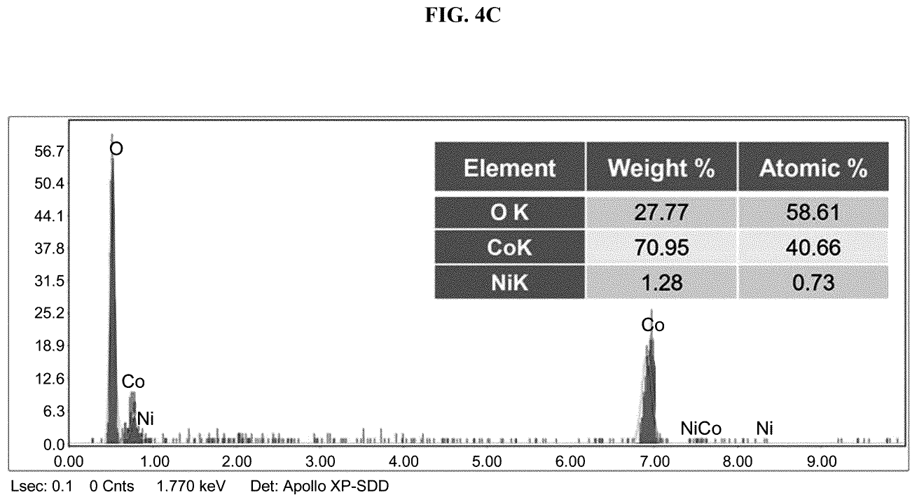

FIGS. 4A to 4C illustrate views of physicochemical characteristics of a binder-free electrode according to an embodiment of the present disclosure.

Referring to FIG. 4A, it shows actual photographs comparing a substrate (bare Ni foam) with a substrate (Ni foam on which cobalt hydroxide is formed) after hydrothermal synthesis.

FIGS. 4B and 4C show Energy dispersive X-ray spectroscopy (EDX) mapping images for the binder-free electrode, which is a cobalt oxide/Ni foam composite, and the elemental evolution spectrum for the cobalt oxide/Ni foam composite, respectively. EDX mapping images show the uniform distribution of the synthesized cobalt oxide on the Ni foam after applying Joule heating within the input parameters (4.5 V and 50 A).

In embodiments, when cobalt hydroxide on Ni foam (Co(OH)₂@Ni foam), which is the hydrothermally synthesized substrate, was subjected to Joule heating (under the condition of input voltages 4.5 V and current 50 A) for 5 seconds and successive cooling for 20 seconds, the cobalt hydroxide on Ni foam in pink color completely transformed into a modified cobalt oxide/Ni foam composite (CoO/Co₃O₄@Ni foam) in black color. Here, the time cycle between the heating and cooling durations of 5 seconds and 20 seconds, respectively, is denoted as one cycle of the electrothermal wave because it could satisfy the complete conversion and stabilization of the cobalt oxide-based electrodes via rapid heating and ambient cooling.

### Preparation of Embodiments

A hydrothermal synthesis was applied for the pre-formation of cobalt hydroxide (Co(OH)₂) nanostructures on Ni foam.

First, Ni foam (MTI, EQ-bcnf-500 μm, 500 μm thickness, Republic of Korea) was cut into a size of 2.5×5 cm². The tailored Ni foam was sonicated in 30 mL of HCl solution (3M) for 15 min to clean the rough surface and then washed with deionized (DI) water and ethanol. One side of the cleaned Ni foam was sealed using Kapton tape. Cobalt nitrate (2 mmol, Co(NO₃)₂·6H₂O, Sigma-Aldrich, Mn˜291.03 g), ammonium fluoride (8 mmol, NH₄F, Sigma-Aldrich, Mn˜37.04 g), and urea (10 mmol, CO(NH₂)₂, Sigma-Aldrich, Mn˜60.06 g) were dissolved in 40 mL of DI water and stirred to form a homogeneous solution. After immersing the pre-treated Ni foam completely in the precursor solution, it was transferred into a 50 mL Teflon-lined stainless-steel autoclave. The autoclave was then heated in an oven (CORETECH, HQ-FD084, Republic of Korea) for 9 h at 120° C., and naturally cooled to 25° C. The resulting products, obtained from the remaining solution, were ultrasonically cleaned in DI water and ethanol for 15 min and dried overnight at ˜25° C. while the Kapton tape was removed from the Ni foam before the ultrasonication process.

Tunable fabrication of cobalt oxide (CoO/CO₃O₄) nanostructures on Ni foam was implemented using a Joule-heating-driven electrothermal wave.

The prepared Ni foam including cobalt hydroxide (Co(OH)₂) nanostructures on the surfaces were cut into a size of 2.5×1.5 cm², and the home-made Cu blocks, connected with a DC power supply (Unicorn TMI, Udp-3050, Republic of Korea) were attached to both the ends of Ni foam.

Then, programmable electrothermal waves through diverse pulse cycles were applied to the Ni foam while a fixed voltage input was used to maintain the constant input energy. By experimentally adjusting the input power and multiple pulse duration for the transition to the cobalt oxides, the optimal input voltage and current were fixed at 4.5 V and 50 A, respectively, for a single pulse.

The sustained duration of the single pulse (heating) and idle time for the next pulse input (cooling) were set to 5 seconds and 20 seconds, respectively. The number of pulse cycles for electrothermal waves was varied between #1 and #15 to investigate the specific transition of the multiphase structure and oxygen vacancies for cobalt oxide nanostructures on Ni foam.

In other words, cobalt hydroxide (Co(OH)₂@Ni foam) on the Ni foam, which is the hydrothermally synthesized substrate, was transformed into a cobalt oxide/Ni foam composite (CoO/Co₃O₄@Ni foam) by applying Joule heating for 5 seconds (under the conditions of input voltage 4.5 V and current 50 A) followed by successive cooling for 20 seconds. As a result, a binder-free electrode (E-CN) was successfully fabricated.

During the existence of electrothermal pulses, the real-time temperature change was measured using a thermocouple (OMEGA Engineering, K type, USA). The corresponding voltage and current were recorded using a clamp meter (Testo, Testo 770-3, Germany).

### Preparation of Embodiment 1

Electrothermal waves were applied in a pulse cycle of a heating duration of 5 seconds and a cooling duration of 20 seconds to the substrate hydrothermally synthesized according to Embodiment to synthesize a cobalt oxide/Ni foam composite (CoO/Co₃O₄@Ni foam). As a result, a binder-free electrode (E-CN-1) was fabricated.

### Preparation of Embodiment 2

The pulse cycle of electrothermal waves was repeated five times to the substrate hydrothermally synthesized according to Embodiment to synthesize a cobalt oxide/Ni foam composite (CoO/Co₃O₄@Ni foam). As a result, a binder-free electrode (E-CN-5) was fabricated.

### Preparation of Embodiment 3

The pulse cycle of electrothermal waves was repeated ten times to the substrate hydrothermally synthesized according to Embodiment to synthesize a cobalt oxide/Ni foam composite (CoO/Co₃O₄@Ni foam). As a result, a binder-free electrode (E-CN-10) was fabricated.

### Preparation of Embodiment 4

The pulse cycle of electrothermal waves was repeated fifteen times to the substrate hydrothermally synthesized according to Embodiment to synthesize a cobalt oxide/Ni foam composite (CoO/Co₃O₄@Ni foam). As a result, a binder-free electrode (E-CN-15) was fabricated.

### Preparation of Comparative Example

Using the conventional annealing method, a substrate on which a cobalt precursor is formed was heated in a furnace at 400 degrees Celsius for 4 hours to complete Comparative Example (A-CN).

In other words, the cobalt oxide phases, synthesized by an annealing process involving long-time heating conditions (4 h at 400° C., CORETECH, HQ-DMF 3, Republic of Korea), were prepared as a control to elucidate the distinct structures and chemical compositions, realized with multiple electrothermal cycles.

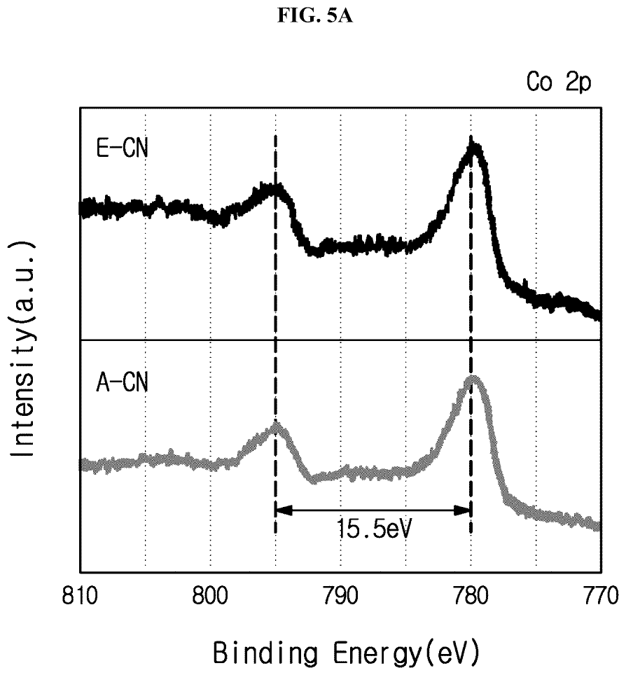

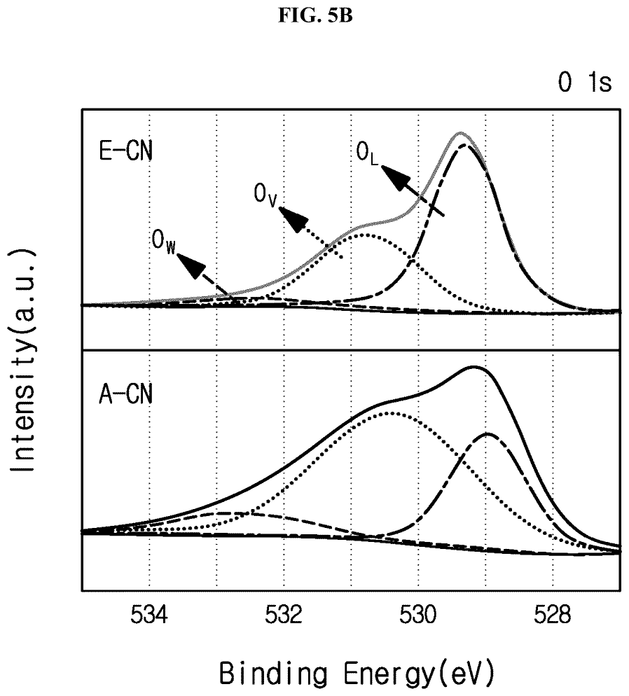

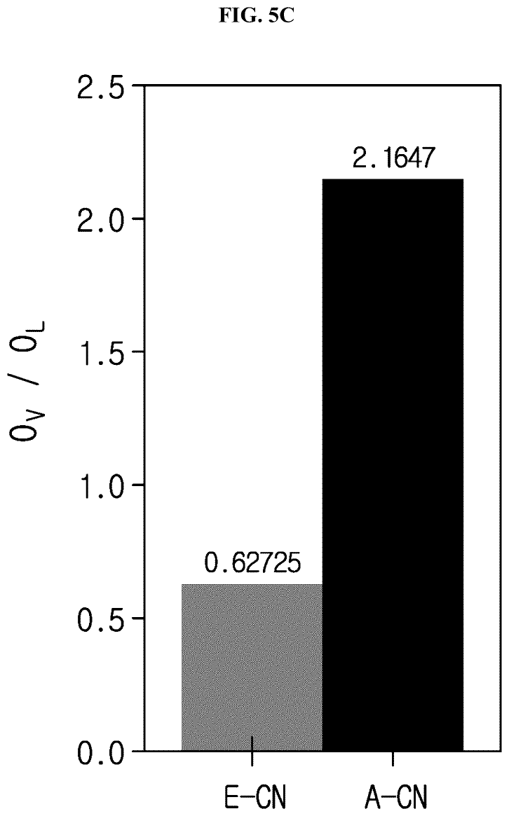

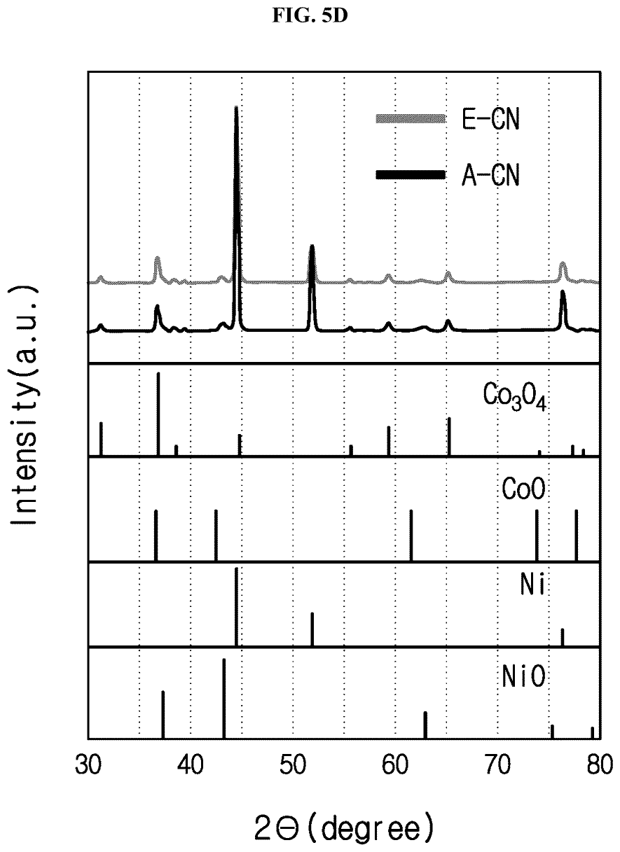

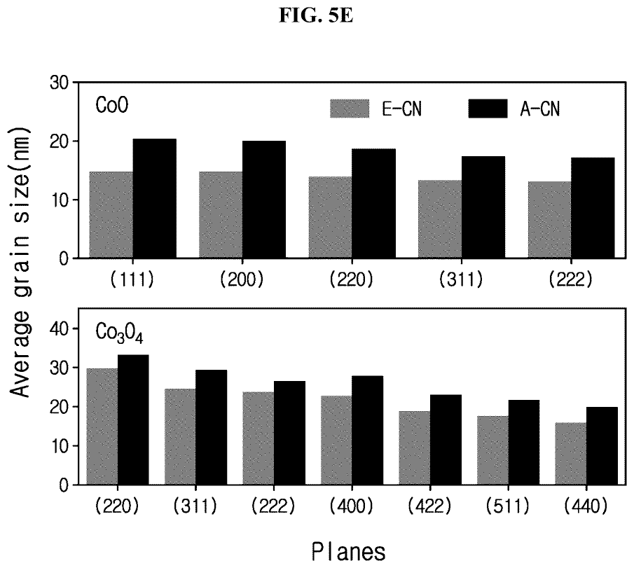

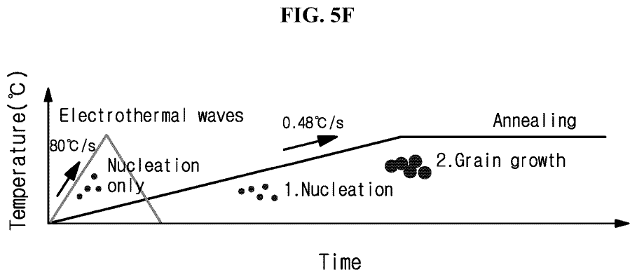

FIGS. 5A to 5F illustrate views of a comparison of the physicochemical characteristics between a binder-free electrode according to various embodiments of the present disclosure and a comparative example.

Field-emission scanning electron microscopy (SEM; FEI, Model Quanta 250 FEG; Jeol, Model JSM-6701 F) and energy dispersive X-ray spectroscopy (EDX; FEI, Tecnai G2 F3OST) were used to examine the surface morphology and chemical composition of the Co(OH)₂ and CoO/CO₃O₄ nanostructures on the Ni foams. Thermogravimetric analysis (TGA, TA Instruments, SDTQ600/DSCQ20 System, USA) was used to determine the thermodynamic phase transitions and chemical decompositions of the precursor mixtures over a range of temperatures. The specific surface areas and pore dimensions were calculated according to the Brunauer-Emmett-Teller (BET) method using nitrogen adsorption-desorption isotherms (Micrometritics, TriStar II 3020). More specific physicochemical configurations, adjusted by the pulse cycles of electrothermal waves, were investigated using X-ray photoelectron spectroscopy (XPS; Ulvac-phi, X-tool) and X-ray diffraction (XRD; Rigaku, SmartLab) at a scanning rate of 2° min⁻¹ with 2θ in the range of 10-90°. Further analyses of the XRD patterns in terms of the quantified dataset were performed using the Rietveld refinement method obtained from the Material Analysis Using Diffraction (MAUD) program.

FIGS. 5A to 5C show X-ray photoelectron spectroscopy spectra for an embodiment and a comparative example.

The X-ray photoelectron spectroscopy (XPS) spectra of both an embodiment (E-CN) and Comparative Example (A-CN) show two prominent peaks (Co 2p_{3/2}, and 2p_{1/2}) separated by 15.5 eV, which confirms the presence of CO₃O₄ as the main phase of the active materials.

The O 1s spectra of the embodiment (E-CN) and Comparative Example (A-CN) present three deconvoluted components centered at approximately 529, 531.3, and 532.7 eV, indicating lattice oxygen atoms (O_{L}), oxygen vacancies (O_{V}), and water molecules (Ow), respectively. The relative portions of these oxygen species can be analyzed using the integrated areas of the individual subpeaks. The O_{V}/O_{L} ratios in A-CN were significantly higher than those in E-CN. Thus, it was confirmed that the embodiment (E-CN) was synthesized with fewer oxygen vacancies compared to Comparative Example (A-CN). In addition to the rapid heating-cooling effect, the electrothermal wave accompanies electric current flow, and sufficient electrons can be provided to the active materials. Thus, the coexistence of the electron-donors and strong electrical force strengthens the bond of oxygen with the center of the lattice, thereby suppressing the formation of oxygen vacancies.

FIG. 5D illustrates a graph showing the X-ray diffraction (XRD) pattern results for one embodiment of the present disclosure and Comparative Example.

Referring to FIG. 5D, XRD patterns were recorded using the Rietveld refinement method. Both the CoO/Co₃O₄@Ni foams in E-CN and A-CN show three major peaks at 44.5°, 51.9°, and 76.4°, which correlate with the (111), (200), and (220) reflections of Ni foam (JCPDS card no. 4-0850). The characteristic peaks of NiO, indicates the existence of a slightly oxidized surface on the Ni substrate, and can be observed in the patterns (JCPDS card no. 73-1523). Furthermore, the diffraction peaks were appropriately indexed to cubic phase CO₃O₄ (JCPDS card no. 42-1467). The characteristic peaks of CoO, which is a reduced phase of CO₃O₄ appeared in both E-CN and A-CN (JCPDS card no.43-1003). Thus, the cobalt oxides obtained from the thermal processes were confirmed to be multivalent cobalt oxides.

FIG. 5E illustrates a graph showing the grain size analysis for an embodiment of the present disclosure and a comparative example.

Referring to FIG. 5E, the average grain dimensions of the resulting products in E-CN and A-CN were analyzed by Debye-Scherrer equation.

$$D = \frac{0.9 λ}{β cos θ} , \qquad ( 2 )$$

where λ denotes the X-ray wavelength, β denotes the full-width at half-maximum, and θ denotes the Bragg angle. The grain size of A-CN is larger than that of E-CN on all crystalline plane surfaces. Thus, it was confirmed that the overall grain size of cobalt oxide according to the embodiment (E-CN) is smaller than that according to Comparative Example (A-CN).

FIG. 5F illustrates a time-dependent temperature graph showing the kinetic growth of grain size according to an embodiment (E-CN) of the present disclosure and Comparative Example (A-CN).

The instantaneous yet enormous input thermal energy from the rapid heating-cooling process in electrothermal waves according to the embodiment (E-CN) facilitates the formation of a heterojunction interlayer structure in CoO/CO₃O₄, owing to the generation of high surface energy and mitigation of further thermal energy penetration into the inner structures. While the thermal diffusion process in the solid state intrinsically requires time to extend the thermal boundary layer, electrothermal waves supply extreme thermal energy in a short duration, thereby preserving the short thermal boundary layer and suppressing the continuous growth of the grain boundaries.

However, the annealing process employing the slow heating-cooling curves inevitably involves excess time to cause the gradual growth of the grain through nucleated CoO/CO₃O₄ nanostructures and loosens the surface energy, thereby decreasing the grain boundary density.

Multiple Electrothermal Waves for Extending Tunable Physicochemical Properties

Multiple electrothermal waves of repetitive cycles consisting of 5-second heating and 20-second cooling can extend the supplied energy and corresponding tunable properties, such as the grain size and oxygen vacancies in active materials, thereby efficiently screening the optimal physicochemical conditions of binder-free CoO/Co₃O₄@Ni foams as electrochemical electrodes.

The real-time voltage and current profiles of multiple electrothermal waves confirmed the nearly constant input conditions, even though they were slightly lower than those of the input parameters (4.5 V and 50 A). Simultaneously, the corresponding supplied energy at the individual electrothermal wave, calculated by the measured voltage and current profile, was maintained between 120 and 170 J cm⁻², which overcame the supplied energy from the annealing process.

In terms of the energy input per unit time, the electrothermal waves provide enormous amount of input energy (˜135.8 J cm⁻²) to the substrate in seconds, whereas the annealing process only supplies 13.6 J cm⁻² despite heating for several hours.

The net energy supplied to the substrate during the high-temperature thermal processes was estimated using heat transfer analysis. The electrothermally generated heat can be classified as dissipated thermal energy or partially consumed internally stored thermal energy.

Firstly, when heat is generated using Joule-heating in the middle of the substrate, the specific temperature gradient occurs, and heat is transferred to both sides of the substrate as a form of the conductive heat transfer. Secondly, during the thermal transport processes, the convective heat transfer from the substrate is delivered to the surroundings due to the temperature difference between the substrate and the open-air environment(˜25° C.). Lastly, the radiative heat transfer is induced by the temperature difference between the heated substrate and the ambient grey body. The multiple modes of heat transfer inevitably draw out the thermal energy received from the Joule-heating, thereby causing a heat loss of 45.5 J cm⁻² in each cycle of electrothermal waves.

In addition to heat transfer, as the temperature of the electrode rises, the internal energy of the CO₃O₄ and Ni foam on the substrate increases, which absorbs energy of 6.7 J cm⁻² from the energy received from the thermal process. On the contrary, in the annealing process, heat transfer is negligible due to the slow and uniform heating, and an energy of 6.1 J cm⁻² is used as internal energy, leaving only 7.5 J cm⁻², which is difficult to exceed the threshold level of phase activation. However, the remnant energy (˜83.6 J cm⁻²) in the electrothermal waves sufficiently surpasses the activation energy of the additional phase transitions, which can lead to grain growth and reduction of active materials.

Therefore, as the cycles of the electrothermal waves proceed, the phase of the active materials on the substrate can be functionally reformed, and the degree of transition differs in proportion to the amount of accumulated energy. In other words, the adjustment of the grain sizes and reduced states of CoO/CO₃O₄ nanostructures can be achieved by controlling the number of the cycles for electrothermal waves.

Phase Transition Change for Binder-Free Electrode (CoO/Co₃O₄(@Ni Foam) Using Programmable Electrothermal Waves

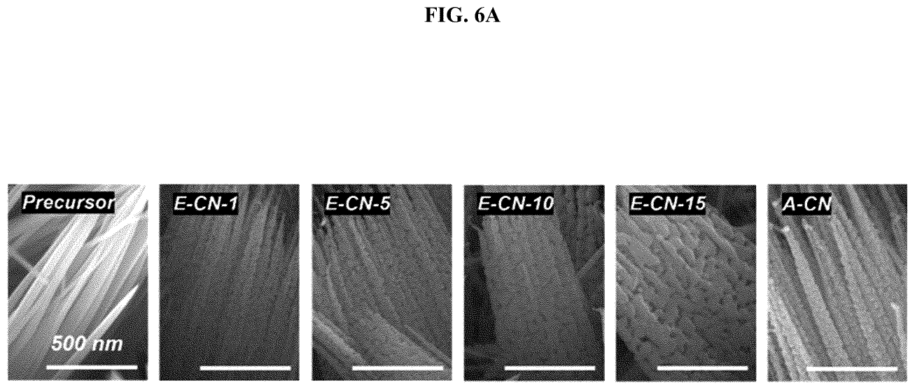

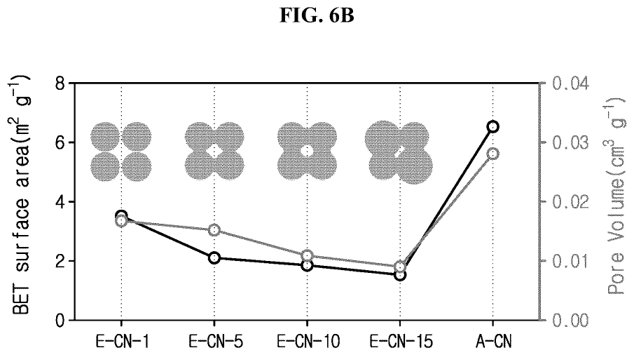

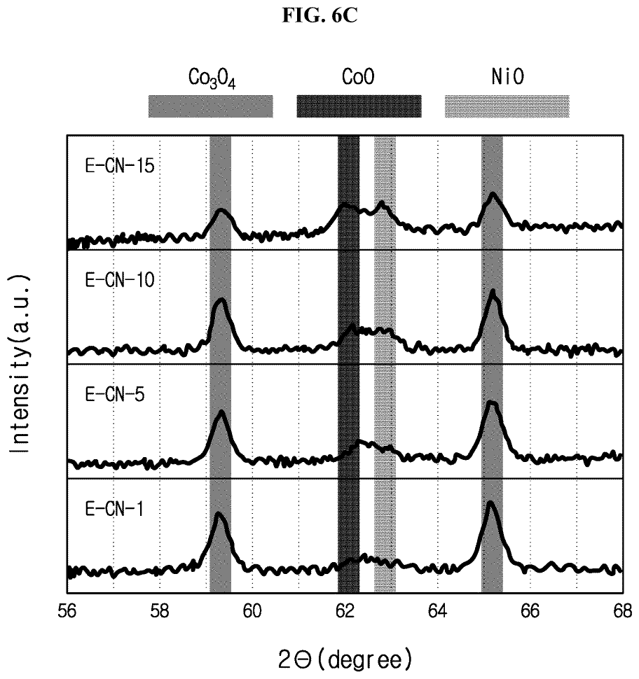

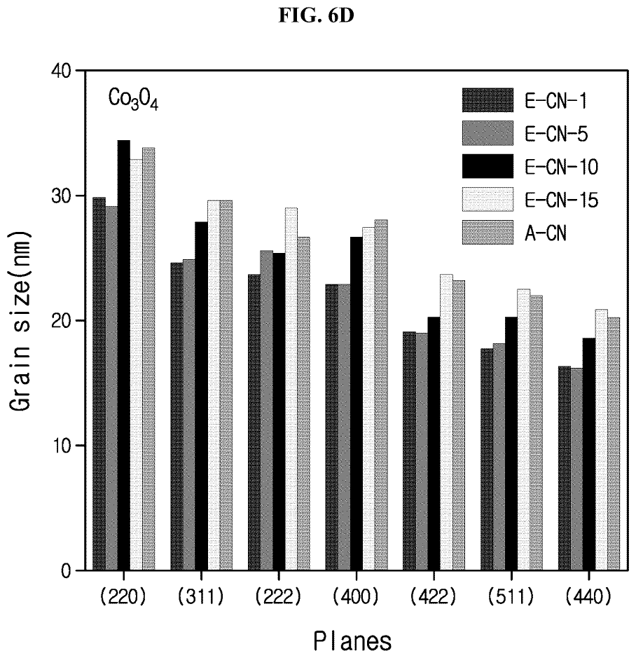

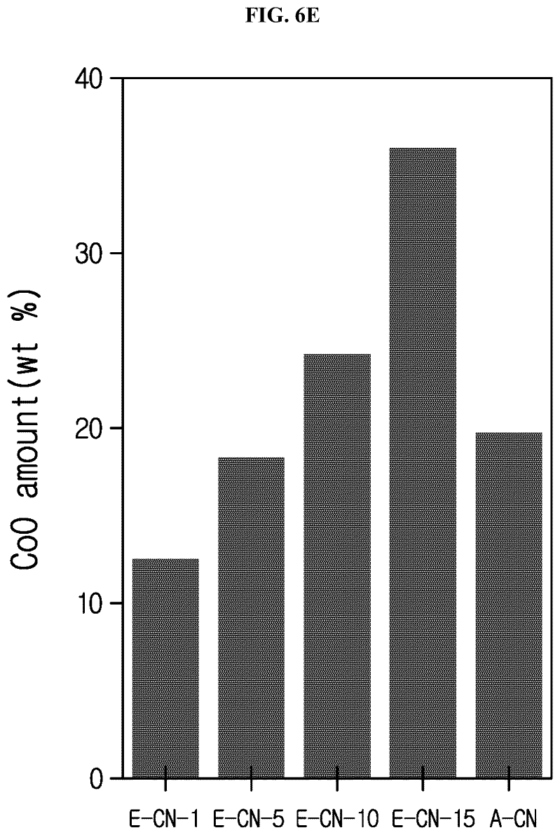

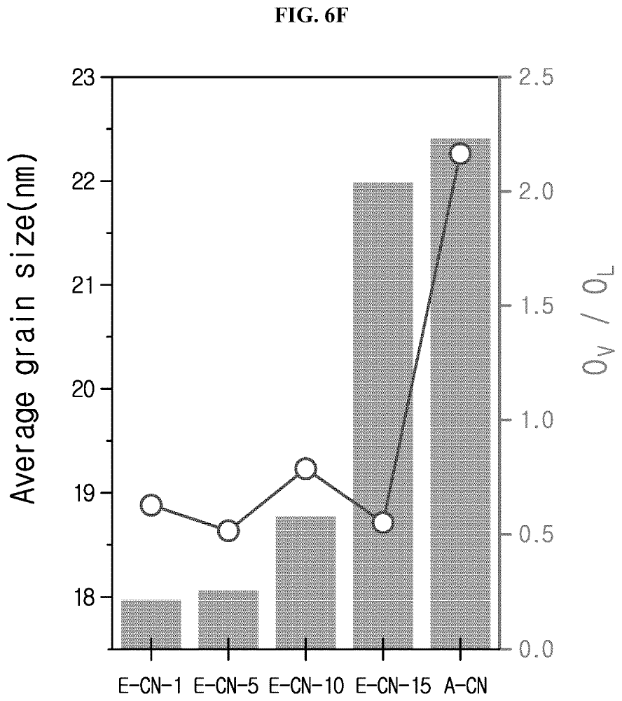

FIGS. 6A to 6F illustrate views of phase transition changes between a binder-free electrode according to various embodiments of the present disclosure and a comparative example.

Referring to FIGS. 6A to 6F, the changes in the properties of cobalt oxide were examined while repeatedly applying electrothermal waves for 1, 5, 10, and 15 times, and through this, a physicochemical design strategy for transition metal oxide through the electrothermal waves was presented. Through scanning electron microscopy, surface area analysis, and X-ray diffraction analysis, it was confirmed that as the number of cycles of multiple electrothermal waves increased, the grain size increased while the surface area decreased. Furthermore, it was confirmed that the electrothermal waves induced the reduction reaction of cobalt oxide. Through this, it was found that the additional electrothermal waves caused particle aggregation, and it was confirmed that the energy remaining after being used for heat transfer and internal energy among the applied energy caused a reduction reaction of cobalt oxide and particle aggregation. Additionally, it was confirmed that the quantity of oxygen vacancies remains constant even with repeatedly applying electrothermal waves. This demonstrated that electrothermal waves could independently control the structural and chemical characteristics of transition metal oxide.

Preparation of Various Binder-Free Electrodes (CoO/Co3O4(@Ni Foam) by Using Programmable Electrothermal Waves

FIG. 6A illustrates an image showing the phase transition of the cobalt oxide/Ni foam composite according to various embodiments of the present disclosure and a comparative example. FIG. 6B illustrates a graph showing the BET surface area and pore volume results of cobalt oxide/Ni foam composite according to various embodiments of the present disclosure and a comparative example.

The grain sizes of CoO/CO₃O₄ fabricated according to Embodiments 1 to 4 were examined using the transition of the morphological structures according to the number of cycles for electrothermal waves (#1 to #15: E-CN-1 to E-CN-15). As the number of cycles increases, more agglomerated cobalt oxide nanostructures appear in the fabricated structures. Additionally, only the phase transition between the cobalt hydroxide and oxides occurred owing to the significantly lower temperature compared to the melting points of CO₃O₄ (895° C.) and CoO (1,935° C.).

They were not liquefied at all, thereby preserving their needle-like nanoarray structures. Subsequently, by increasing the number of electrothermal cycles that exceed the activation energy of the grain growth, gradual agglomeration of the nanoparticles along the needle-like structures appeared in the entire cobalt oxide. This structural transformation produced a highly porous morphology fabricated during the oxidation of cobalt hydroxide (Co(OH)₂) at the first electrothermal wave, which is gradually degraded, and the exposed surface areas decreased as the number of cycles increased. The Brunauer-Emmett-Teller (BET) specific surface areas of the E-CNs, fabricated by the different number of electrothermal waves (3.49, 2.09, 1.85, and 1.54 m² g⁻¹ for E-CN-1, E-CN-5, E-CN-10, and E-CN-15) confirmed the reduction of the active surface area of the cobalt oxides via the increased cycles. In the end, the BET surface area and pore volume vary according to different cycles of electrothermal waves.

FIG. 6C illustrates a graph showing the X-ray diffraction (XRD) pattern results of the cobalt/Ni foam composite according to various embodiments of the present disclosure and a comparative example. FIG. 6D illustrates a graph showing the grain size on the planar surface of the cobalt oxide/Ni foam composite according to various embodiments of the present disclosure and a comparative example.

Moreover, the grain sizes of the CoO/CO₃O₄ nanoparticles obtained from the XRD data could clarify the growth of the grains according to the increase in electrothermal cycles. For instance, Embodiment 4 (E-CN-15) presented the largest grain size (˜21.99 nm), indicating a relatively low grain boundary density, thereby reducing the Li-ion diffusion into the active material. In addition to supplying excess energy over the threshold energy level for grain growth in the CoO/CO₃O₄ nanostructures, increasing the number of electrothermal waves facilitates the reduction of CO₃O₄.

FIG. 6E illustrates a graph showing a comparison of the amount of CoO in the cobalt oxide/Ni foam composite according to various embodiments of the present disclosure and the comparative example.

The relative proportions of CoO and CO₃O₄ were examined using Rietveld refinement. The quantitative analyses of the reduced states from the Embodiment 1 (E-CN-1) to Embodiment 4 (E-CN-15) were conducted, where the CoO amount gradually increased from 12.63% to 36.08%, whereas that for the Comparative Example (A-CN) was 19.84%. These results indicated that the morphological characteristics and chemical composition, such as the exposed surface areas, grain sizes, and reduced states, can be simultaneously tuned by simply adjusting the number of applied electrothermal waves.

FIG. 6F illustrates a graph showing a comparison of oxygen vacancies of cobalt oxide/Ni foam composites according to various embodiments of the present disclosure with a comparative example.

Since the electrothermal waves employing electric current flows strengthen the oxygen bonding and inhibit the formation of oxygen vacancies, the total number of oxygen vacancies did not change, even as the number of cycles of the electrothermal waves increased, and the O_{V}/O_{L} ratio remained below 1.0. Therefore, the adjustable cycle numbers of the electrothermal waves enable the active manipulation of the grain size and relative composition of the interlayer CoO/CO₃O₄ while maintaining the concentration of oxygen vacancies.

Electrochemical Characterization of Co₃O₄(PNi Foam-Based Binder-Free Electrodes

Hereinafter, the electrochemical performance based on the structural and chemical differences of the active materials were investigated. A binder-free electrode, prepared according to the embodiments, was directly assembled into a coin half-cell for electrochemical measurements without additional heat treatment. Initially, cyclic voltammetry (CV) and galvanostatic charge-discharge (GCD) tests were conducted to confirm that the synthesized cobalt oxide/Ni foam composite indeed reacted with lithium ions as a transition metal oxide-based anode. Subsequently, the charge-discharge performance of the composites was compared, and it was confirmed that higher grain boundary density can significantly enhance capacity. Additionally, by optimizing the suppression of oxygen vacancies, it was observed that it is possible to prevent the irregular volume expansion of cobalt oxide during charge and discharge, ensuring a longer lifespan for the battery. Through electrochemical impedance spectroscopy (EIS) measurements, the structural stability of the optimized composite in charge and discharge processes was revalidated. Additionally, by performing cyclic voltammetry (CV) with varying scan rates, the position of peaks at different scan rates was calculated, revealing performance mechanisms based on the differences between composites manufactured according to examples and comparisons.

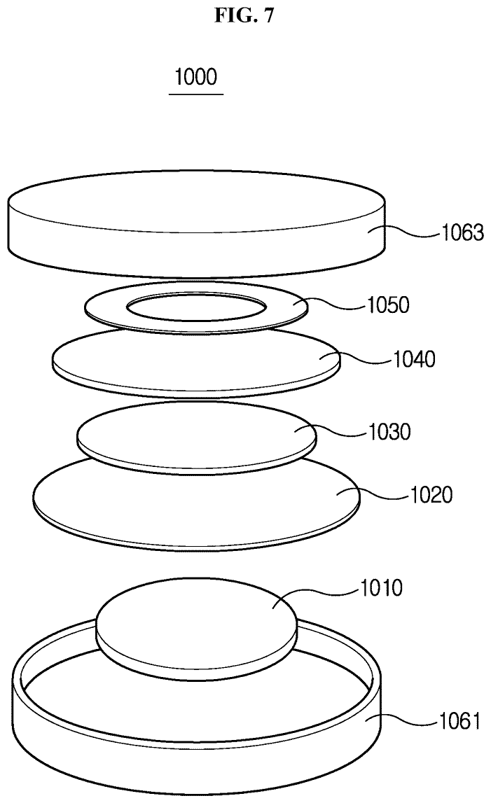

FIG. 7 illustrates an example view of the structure of a lithium secondary battery using a binder-free electrode according to an embodiment of the present disclosure.

Referring to FIG. 7, a cobalt oxide/Ni foam composite (CoO/Co₃O₄@Ni foam) prepared according to Embodiment 1 (E-CN-1) was directly used as a binder-free electrode without any post-treatment. The binder-free electrode 1010 based on the cobalt oxide/Ni foam composite (CoO/Co₃O₄@Ni foam) was tailored to a circular shape with a diameter of 12.7 mm.

The cut binder-free electrodes were assembled into CR2032 coin cells 1000.

The coin cell 1000, a lithium secondary battery, may be assembled by stacking the following: on a base 1061, a binder-free electrode 1010, a separator 1020 containing an electrolyte, a lithium chip 1030, a spacer 1040, and a spring 1050, and then covering them with a lead 1063.

The lithium chip 1030 served as a counter and a reference electrode. The mass loading density of the active materials in the working CoO/Co₃O₄@Ni foam-based electrode was 2.37 mg cm⁻², which was measured on an analytical balance (Ohaus, EX125D, USA).

In the coin cell 1000, 1 M LiPF₆ in a mixture of ethylene carbonate and diethyl carbonate (w/w 1:1) was used as the electrolyte.

All the assemblies were completed in an Ar-filled glove box. The assembled coin cell 1000 was tested on a WBCS3000 battery tester (WonATech). To elucidate the electrochemical characteristics of the CoO/Co₃O₄@Ni foam-based binder-free electrodes, fabricated using differently programmed conditions of electrothermal waves, the cyclic voltammograms (CVs) were measured within a voltage window between 0.01 and 3.0 V at various scan rates of 0.1, 0.2, 0.4, 0.6, 0.8, and 1.0 mVs⁻¹, while a galvanostatic charge-discharge test was conducted within a voltage window between 0.01 and 3.0 V at a current density of 1.2 mA cm-2. An Electrochemical impedance spectroscopy (EIS) analysis was performed in the frequency range of 105-0.01 Hz using a Zive MP1 (WonATech).

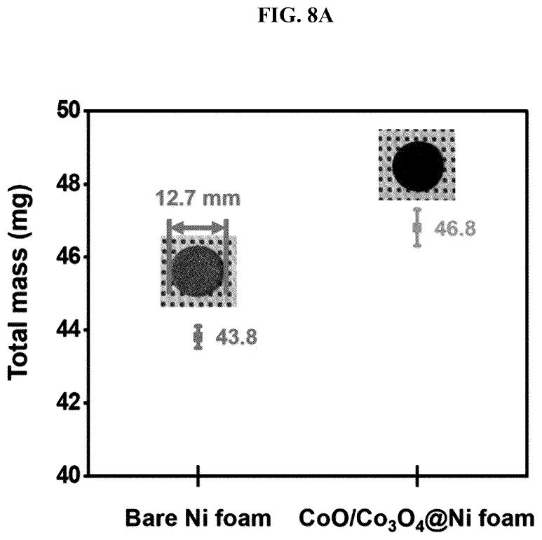

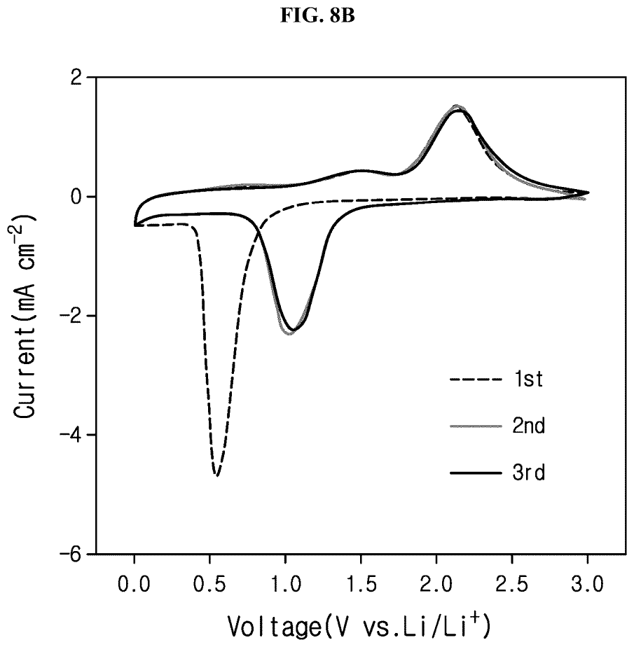

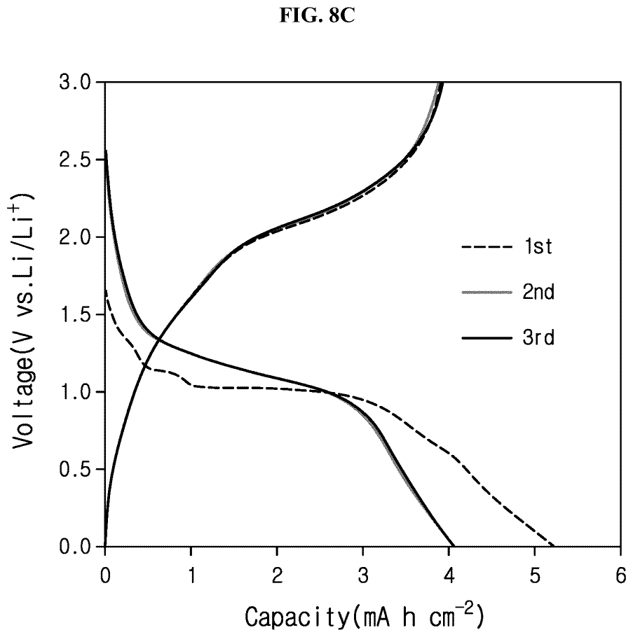

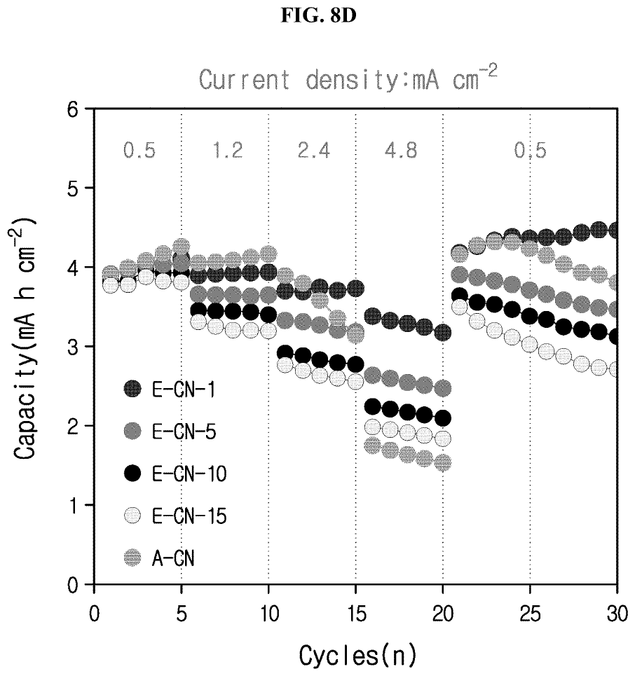

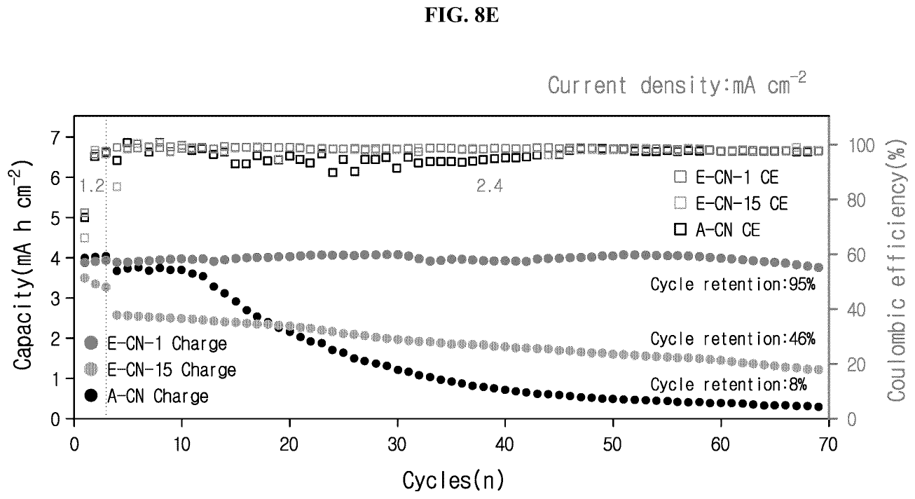

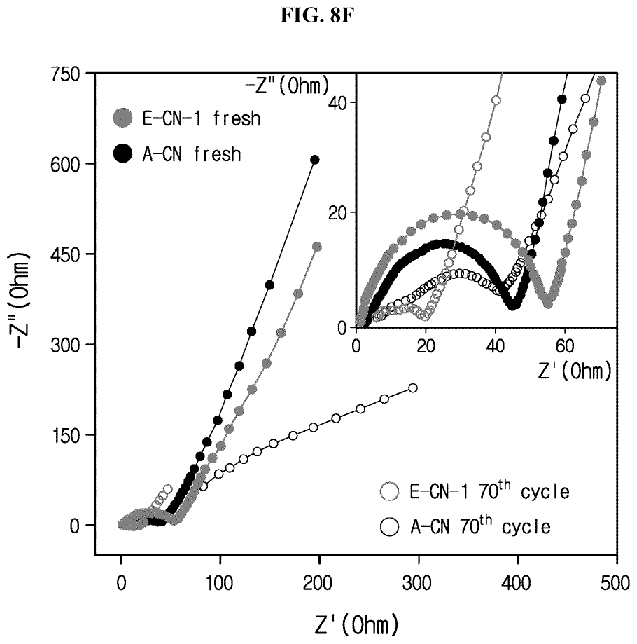

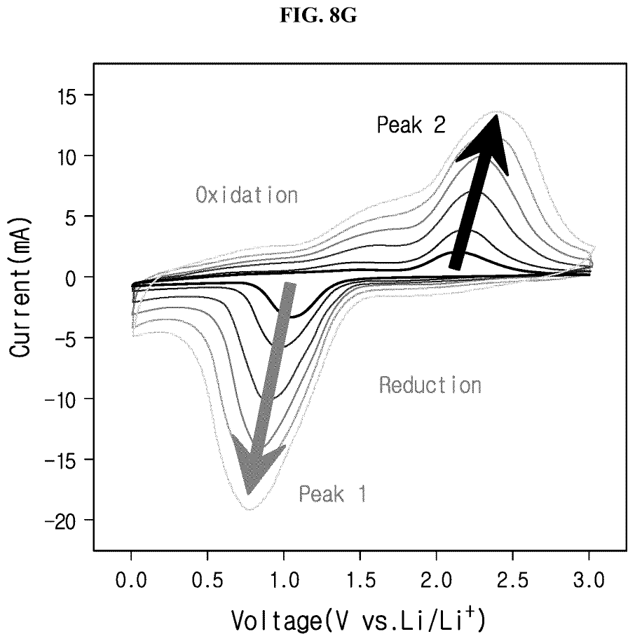

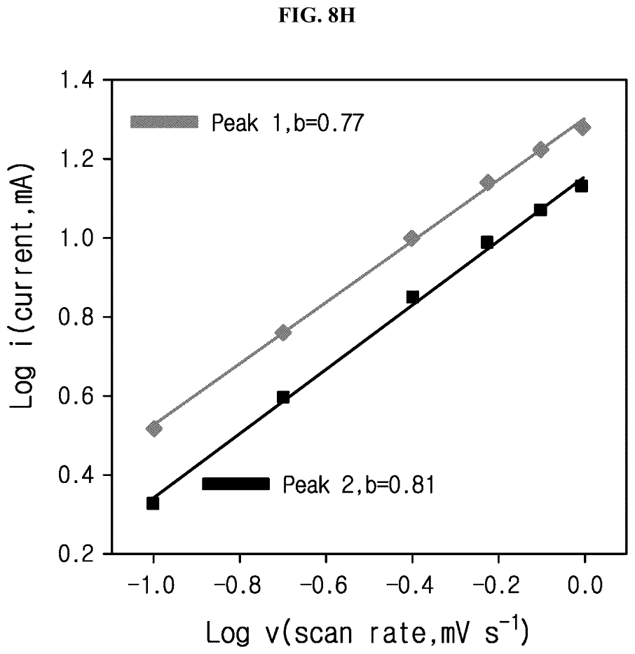

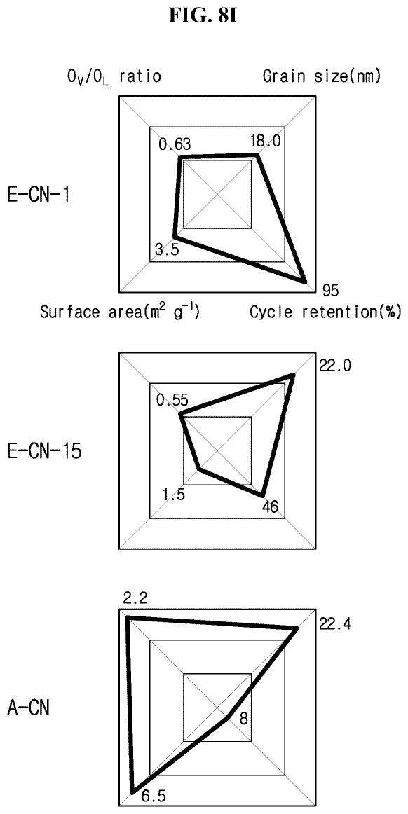

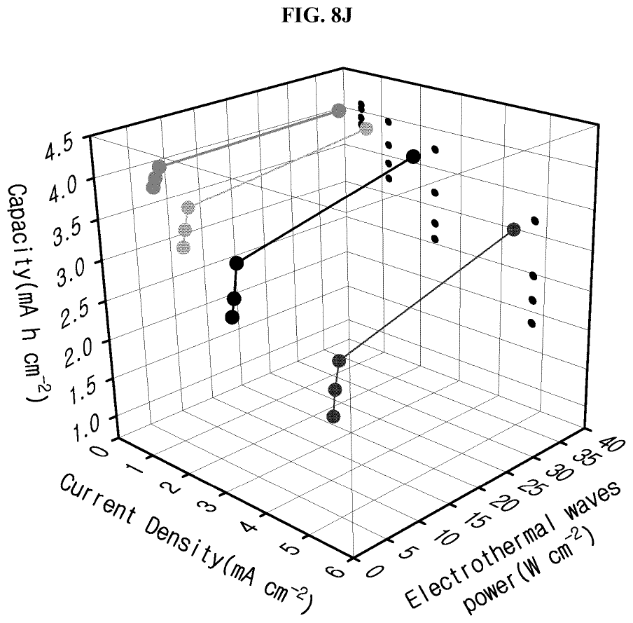

FIGS. 8A to 8J illustrate views of a comparison of the electrochemical characteristics between the lithium secondary battery in FIG. 7 and a comparative example.

Referring to FIG. 8A, a comparison of the mass of the bare Ni foam and a binder-free electrode according to an embodiment of the present disclosure is shown. In the binder-free electrode (CoO/Co₃O₄@Ni foam), the loading mass of the active material in CoO/Co₃O₄@Ni foams (footprint area: 1.27 cm²) was 3.0 mg, which was calculated as the difference in the mass of the electrode before and after synthesis.

FIG. 8B shows a cyclic voltammetry (CV) curve of a binder-free electrode according to one embodiment of the present disclosure.

Referring to FIG. 8B, cyclic voltammogram (CV) curves for three cycles at a scan rate 0.1 mVs⁻¹ between 0.01 and 3.0 V (vs. Li⁺/Li) were measured.

In the cyclic voltammetry (CV) curves of Embodiment 1 (E-CN-1) and Comparative Example (A-CN), intrinsic cathodic peaks of the first cycle appeared at 0.54 V and 0.77 V, respectively, and then disappeared in the later cycles. This was strongly associated with the formation of solid electrolyte interphase (SEI), indicating that our electrodes work on the conversion reaction mechanism. After the first cycle, the cathodic peaks were increased to 1.01 and 1.05 V for the second and third cycles (0.88 and 0.89 V for Comparative Example (A-CN)), and the current of the peaks was lower than the first cycle due to the irreversible structure change of the CO₃O₄ electrode. Additionally, the anodic peak of Embodiment (E-CN-1) was observed at 2.11 V (2.12 V for Comparative Example (A-CN)) in the first cycle, which ascribes to the de-lithiation reaction, and was stabilized at 2.14 V (2.18 V for A-CN) in the next cycles.

FIG. 8C illustrates a graph showing a charge-discharge curve of a binder-free electrode according to an embodiment of the present disclosure.

Referring to FIG. 8C, it illustrates galvanostatic charge-discharge (GCD) voltage profiles of Embodiment (E-CN-1) for three cycles between 0.01 and 3.0 V (vs. Li+/Li) at a current density of 1.2 mA cm⁻².

The charge-discharge curves for Embodiment 1 (E-CN-1) and Comparative Example (A-CN) were measured for three cycles at 1.2 mA cm⁻².

The first discharge and charge capacities were obtained as 5.2 and 3.9 mAh cm⁻² for E-CN-1, respectively, while the initial Coulombic efficiency (ICE) was determined as 75%, indicating the formation of SEI film and electrolyte decomposition. Meanwhile, Comparative Example (A-CN) showed relatively lower ICE value of 73% with the 5.5 and 4.0 mAh cm⁻² of the first discharge and charge capacities, respectively, which shows that Embodiment 1 (E-CN-1) has superior irreversibility of conversion reactions than Comparative Example (A-CN). Moreover, the discharge and charge voltage plateaus of 1.0 and 2.0 V of both specimens were consistent with the CV results, verifying that the CoO/CO₃O₄ synthesized by the electrothermal wave and annealing works as a Lithium-ion battery electrode without further additives.

FIG. 8D illustrates a graph showing a comparison of the rate capabilities of a binder-free electrode at various current densities according to an embodiment of the present disclosure.

Referring to FIG. 8D, it illustrates rate capability comparison at different current densities between 0.5 and 4.8 mA cm⁻².

The electrochemical performance of the CoO/Co₃O₄@Ni foam-based anodes was investigated in terms of the rate capabilities at various current densities of 0.5, 1.2, 2.4, and 4.8 mA cm⁻². At a low current density of 0.5 mA cm⁻², Comparative Example (A-CN) exhibited a slightly higher capacity of 4.1 mAh cm⁻² than that of Embodiment 1 (E-CN-1) (˜4.0 mAh cm⁻²). Although the capacity difference was negligible at the current density, the relatively high surface area and extensive oxygen vacancies of A-CN may result in a high capacity.

Additionally, as the current density increased, the difference in capacitance values became distinct, and the larger grain size in the CoO/Co₃O₄@Ni foam-based anodes significantly decreased the capacity. As the grain boundaries serve as functional interfaces for the migration of lithium ions, high density of grain boundaries from the smaller grain sizes facilitates a locally built-in electric field that creates a coulombic force to drive the enhanced transport of lithium ions.

However, larger grains have a relatively low concentration of the grain boundaries concentration, which reduces the mobility of lithium ions, thereby hindering the complete electrochemical reaction of the active material, especially at the high-rate charge-discharge. For instance, the capacity of Comparative Example (A-CN) rapidly decreased at 2.4 mA cm⁻², beginning at 3.9 mAh cm⁻² and ending at 3.1 mAh cm⁻² (10-15 cycles), whereas the Embodiment 1 (E-CN-1) maintained a high-rate capacity of 3.7 mAh cm⁻² at 2.4 mA cm⁻² without degradation. Furthermore, Embodiment 1 (E-CN-1) exhibited an outstanding capacity of 3.3 mAh cm⁻² at 4.8 mA cm⁻² which was 2.0 times larger than that of Comparative Example (A-CN) (˜1.6 mAh cm⁻²).

In addition, other cobalt oxide/Ni foam composite (CoO/Co₃O₄@Ni foam)-based anodes prepared according to other embodiments demonstrated electrochemical performance between Embodiment 1 (E-CN-1) and Comparative Example (A-CN), in terms of the capacity at 4.8 mA cm⁻² (2.6 mAh cm⁻², 2.2 mAh cm⁻², 1.9 mAh cm⁻² for E-CN-5, E-CN-10, and E-CN-15, respectively). These comparable capacities confirmed that larger grain sizes cause severe capacity degradation as the current density increases. After 20 charge-discharge cycles in the low and high current densities, the Embodiment 1 (E-CN-1) showed a superior reversible capacity, increasing from 4.2 to 4.5 mAh cm⁻² at 0.5 mA cm⁻² over 10 cycles, whereas the other cobalt oxide/Ni foam composite (CoO/Co₃O₄@Ni foam)-based anodes prepared according to other embodiments revealed a decrease in capacity.

FIG. 8E illustrates a graph showing the charge-discharge cycling measurement results of a binder-free electrode according to an embodiment of the present disclosure.

Referring to FIG. 8E, long-term charge-discharge cycling stability between 0.01 and 3.0 V (vs. Li⁺/Li) at a current density of 2.4 mA cm⁻² was measured.

The long-term charge-discharge cycling measurement at a current density of 2.4 mA cm⁻² clearly presents the specific differences in the electrochemical characteristics of the tested electrodes.

Throughout 70 charge-discharge cycles, Embodiment 1 (E-CN-1) and Embodiment 4 (E-CN-15) maintain 95% and 43% cycle retentions that are significantly differentiated by the grain sizes synthesized by different thermal energy inputs. Moreover, this trend was confirmed by Comparative Example (A-CN), which revealed a significant decrease in the capacity retention (˜8%) after only 10 cycles. Based on the storage mechanism of CoO, and CO₃O₄, the conversion reaction can be expressed as follows:

CoO+2Li⁺+2e⁻↔Co+Li₂O, (3)

Co₃O₄+8Li⁺+8e⁻↔+3Co+4Li₂O, (4)

In the first discharging process, chemical bonds of CoO and CO₃O₄ are broken and converted into Co metal, and lithium is stored in the form of Li₂O. During this process, the initial crystal structure of CoO and CO₃O₄ is collapsed to become irreversibly amorphous having a structure in which Co metal is dispersed in the Li₂O matrix. Meanwhile, in the charge process, Li₂O is reduced and the Co metal is oxidized and converted into CoO and CO₃O₄. Li₂O is an insulator, which is the cause of lowering the following charging/discharging reactions.

If the sufficient conversion is not achieved due to the imbalanced ion transportation and low conductivity at a high-current cycling, a residue of Li₂O is formed and lower the overall capacitance of batteries. Thus, while a moderate concentration of oxygen vacancies can enhance the lithium diffusion rate, excess or deficient vacancies may cause phase transitions in the materials due to the changes introduced in electronic structure and lattice strain, which results in the promotion of mechanical diffraction.

Thus, based on the relative comparison between the E-CN and A-CN electrodes according to the embodiments and comparative example, as well as the different numbers of electrothermal waves, the small grain size and moderate oxygen vacancies in the Embodiment 1 (E-CN-1) could contribute to realizing outstanding high-rate capacities and stable cycle retention.

Furthermore, the long-term cycling performance of a substrate (hereinafter referred to as ‘bare Ni foam’) was investigated to clarify the contribution from the active materials.

During the charge-discharge cycles at a current density of 2.4 mAh cm⁻², the bare Ni foam has a low capacity of 0.03 μAh cm⁻² compared with E-CN-1 (3.7 mAh cm⁻²). Because the capacity of the Ni foam was negligible, it was confirmed that the lithium storage properties of cobalt oxide/Ni foam composite (CoO/Co₃O₄@Ni foam) was mostly attributed to the active materials (CoO/CO₃O₄). Based on this rationale, the capacity of Embodiment 1 (E-CN-1) divided by the loading mass represents the specific capacity of CoO/CO₃O₄ and exhibits a high capacity of 1562 mAh g⁻¹, which is higher than the theoretical capacity of CO₃O₄. This might be attributed to that the inherent high surface area of CoO/CO₃O₄ induces the pseudo-capacitance mechanism as well as the conversion mechanism for lithium storage.

FIG. 8F illustrates a graph showing Nyquist plots of a binder-free electrode according to an embodiment of the present disclosure and a comparative example.

Referring to FIG. 8F, Nyquist plots of Embodiment 1 (E-CN-1) and Comparative Example (A-CN) before and after 70 charge-discharge cycling tests show the impedance changes of the electrodes. The semicircle in the high-frequency region indicates the charge transfer resistance (Rot) from electrochemical impedance spectroscopy (EIS) analysis, which represents the interfacial characteristics of the electrode. The slope of the straight line in the low-frequency regime characterizes the diffusion resistance of the electrolyte along the electrode. According to these equivalent circuits, Comparative Example (A-CN) exhibits a lower Rot value and a higher slope of the straight line than the Embodiment (E-CN)-based electrodes.

The active Brunauer-Emmett-Teller (BET) surface area of Comparative Example (A-CN) (6.52 m² g⁻¹) which was larger than that of Embodiment 1 (E-CN-1) (3.49 m² g⁻¹) can improve the interfaces between the electrolyte and active materials for the assembled cells, not experiencing charge-discharge cycles. After 70 charge-discharge cycles at a current density of 2.4 mA cm⁻², Embodiment 1 (E-CN-1) exhibited a smaller R_{ct} value and higher straight slope than Comparative Example (A-CN), thereby confirming the high electrochemical kinetics and structural integrity of the electrothermally fabricated binder-free electrode (CoO/Co₃O₄@Ni foam) during the long-term charge-discharge cycles.

FIG. 8G illustrates a graph showing the CV curve at various sweep rates of a binder-free electrode according to an embodiment of the present disclosure. FIG. 8H illustrates a graph showing a logarithmic plot of a binder-free electrode according to an embodiment of the present disclosure.

Referring to FIGS. 8G and 8H, the CV curves of the electrodes at various scan rates (0.1-1.0 mVs⁻¹) indicated a distinct difference between the fabrication using electrothermal waves and the annealing processes. Both samples obeyed the following equations for the current (i) and scanning rate (v):

i=av^{b}, (5)
where a and b are relevant constants. Peak 1 (anodic peak) and Peak 2 (cathodic peak) are the main peaks where major electrochemical reactions occur, and the corresponding b-values for each peak are derived from the linear slope of the logarithmic plot of peak current and sweep rate. When the b-value approaches 1.0, the electrode exhibits a capacitive electrochemical reaction. By contrast, when it approaches 0.5, the major electrochemical reaction occurs in a diffusion-limited process.

In the cobalt oxide/Ni foam composite (CoO/Co₃O₄@Ni foam)-based electrodes, the b-values of Peak 1/Peak 2 for the anodes fabricated by the electrothermal and annealing processes are 0.77/0.81 and 0.67/0.68, respectively. These CV analyses confirmed that the optimized Embodiment 1 (E-CN-1) conducts electrochemical reactions dominated by the capacitive process, whereas Comparative Example (A-CN) mainly depends on the diffusion-limited process.

The binder-free electrode fabricated according to Embodiment 1 (E-CN-1) can exhibit excellent lithium storage properties for the following mechanisms. First, the small grain size resulted in a high density of grain boundaries, which decreased the length of the lithium-ion pathways and improved the ion diffusion rate. Second, the CoO nanograins nucleated in Co₃O₄ without growing created a high-density interlayer, facilitating better ion transport channels. These unconventional structures and chemical compositions, induced by a highly intensive energy supply through electrothermal waves, led to an unbalanced charge distribution and enhanced ion conduction. Finally, the relatively small yet optimal amount of oxygen vacancies in the CO₃O₄ spinel phase decreased the opportunities for further defect formation and distortions in terms of the host lattice during electrochemical cycling, achieving a higher areal capacity than the previously reported 3D binder-free anodes (Table 1).

TABLE 1

| | Areal capacity | Current density |
|---|---|---|
| Materials | (mAh cm⁻²) | (mA cm⁻²) |
| CoO/Co₃O₄@Ni foam | ~3.7 after 70 cycles | 2.4 |
| Co₃O₄@Carbon cloth | ~3.10 after 100 cycles | 0.5 |
| ZnCo₂O₄@Carbon cloth | ~3.01 after 100 cycles | 0.24 |
| Co₃O₄@CNT hybrid sponge | ~12.0 after 30 cycles | 2.86 |
| Fe—O/Hollow carbon cloth | ~3.81 after 70 cycles | 0.4 |
| FeOₓ@Cu foam | ~2.12 after 500 cycles | 2.5 |

FIG. 8I illustrates a graph showing screening of oxygen vacancies, grain size, surface area, and cycle retention of binder-free electrodes according to various embodiments of the present disclosure and a comparative example.

Referring to FIG. 8I, the mechanism is demonstrated by the precise-screening strategy of the desired cobalt oxide/Ni foam composite (CoO/Co₃O₄@Ni foam) based on the phase maps of morphological and chemical properties synthesized by diverse thermal conditions. While Embodiment 1 (E-CN-1) and Embodiment 4 (E-CN-15) exhibit different cycle retention (95 and 46%, respectively), since they have similar O_{V}/O_{L}ratio (0.63 and 0.55 for E-CN-1 and E-CN-15), it can be confirmed that the larger grain size with lower surface area is the essential factor that decreases the cycle retention. Moreover, Comparative Example (A-CN) has a comparable grain size of 22.4 nm with Embodiment 4 (E-CN-15) (22.0 nm), but exhibits a much lower retention of 8% due to its very high oxygen vacancies concentration, even it has much higher surface area of 6.5 m² g⁻¹ than E-CN-15 (1.5 m² g⁻¹). As a result, through the screening strategy using the phase maps, it was verified that the optimal structure incurring improved lithium storage performance during fast charge-discharge has highly distributed grain boundaries with a small amount of oxygen vacancy.

FIG. 8J illustrates a graph showing comparison of rate capacity based on the electrothermal waves power according to an embodiment of the present disclosure.

Referring to FIG. 8J, for the rational setting of the electrothermal waves parameters for producing optimized grain size and suppressed oxygen vacancy of the binder-free electrode (CoO/Co₃O₄@Ni foam), the rate capacity according to the electrothermal waves power was investigated.

The input power of electrothermal waves was obtained through dividing the accumulated energy applied to the substrate by the total thermal process time (35.99, 6.84, 6.15, and 5.79 W cm⁻² for E-CN-1, E-CN-5, E-CN-10, and E-CN-15). At a current density of 4.8 mA cm⁻², electrothermal wave power of 35.99 W cm⁻² exhibits the highest capacity of 3.2 mAh cm⁻² (2.5 mAh cm⁻², 2.2 mAh cm⁻², 1.8 mAh cm⁻² for 6.84, 6.15, and 5.79 W cm⁻²). The reduction in capacity is the largest when electrothermal waves power falling from 35.99 to 6.84 W cm⁻², which indicates that the high-rate capacity loss greatly occurs from the moment in which the phase transition occurs resulted from the addition of the input energy. Therefore, it is necessary to choose a power higher than 35.99 W cm⁻² by applying the same energy within a shorter time so that no additional phase transition occurs after synthesis of cobalt oxide on Ni foams, implementing highly distributed small nanograins with suppressed oxygen vacancies. This rational synthesis strategy provides a guideline for the fabrication of transition metal oxide-based binder-free electrodes that can achieve improved lithium-ion battery performance.

Furthermore, the precise tuning of the physicochemical properties can be extended to various types of advanced materials, such as liquid metal-based electrodes or contacts. For instance, the electrothermal waves rapidly liquefy electrodes or electrolytes, while the processing parameters including temperature and duration precisely modulate the phases and interfacial contacts.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for manufacturing a binder-free electrode, comprising:
hydrothermally synthesizing a transition metal oxide-based active material on a 3D porous substrate; and
using electrothermal waves to the 3D porous substrate on which the transition metal oxide-based active material is hydrothermal synthesized.

2. The method of claim 1,
wherein the 3D porous substrate comprises a conductive metal material of any one of stainless steel, aluminum, nickel, titanium, and heat-treated carbon.

3. The method of claim 1,
wherein the transition metal oxide-based active material comprises a mixture of inorganic N-based precursors, where N is one or more metals from a group of Mg, Ti, Fe, Cu, Ca, Ba, Y, Sn, Sb, Na, Zn, Zr, Si, Nb, Mo, Ru, Rh, Pd, Ag, Cd, Sc, Ce, Pr, Nd, Gd, Dy, and Er.

4. The method of claim 1,
wherein the hydrothermal synthesis comprises hydrothermally synthesizing a cobalt precursor on a nickel foam.

5. The method of claim 4,
wherein the hydrothermal synthesis comprises forming needle-like nanostructures of cobalt hydroxide on the nickel foam.

6. The method of claim 5,
wherein the using electrothermal waves comprises:
making transition from the cobalt hydroxide to a cobalt oxide by Joule-heating-driven electrothermal waves passing through the nickel foam while preserving the needle-like nanostructures.

7. The method of claim 6,
wherein the using electrothermal waves comprises:
synthesizing a cobalt oxide/nickel foam composite by using Joule heating applying electric energy to both ends of the 3D porous substrate.

8. The method of claim 1,
wherein the using electrothermal waves comprises:
synthesizing a transition metal oxide/conductive substrate composite by Joule heating the 3D porous substrate on which the transition metal oxide-based active material is formed.

9. The method of claim 1,
wherein the using electrothermal waves comprises:
performing a pulse cycle with a heating duration of 5 seconds and a cooling duration of 20 seconds.

10. A binder-free electrode comprising:
a substrate of 3D porous conductive metal material; and
a transition metal oxide-based active material in form of a needle-like nanostructure hydrothermally synthesized on the substrate and then oxidized using electrothermal waves.

11. The electrode of claim 10,
wherein the substrate comprises a conductive metal material of any one of stainless steel, aluminum, nickel, titanium, and heat-treated carbon.

12. The electrode of claim 11,
wherein the substrate is a 3D porous nickel foam.

13. The electrode of claim 10,
wherein the transition metal oxide-based active material comprises a mixture of inorganic N-based precursors, where N is one or more metals from a group of Mg, Ti, Fe, Cu, Ca, Ba, Y, Sn, Sb, Na, Zn, Zr, Si, Nb, Mo, Ru, Rh, Pd, Ag, Cd, Sc, Ce, Pr, Nd, Gd, Dy, and Er.

14. The electrode of claim 10,
wherein the transition metal oxide-based active material is cobalt oxide (CO₃O₄).
